(19) United States
(12) Patent Application Publication
(10) Pub. No.: US 2019/0062196 A1
(43) Pub. Date: Feb. 28, 2019

(54) APPARATUSES AND METHODS FOR LASER PROCESSING TRANSPARENT WORKPIECES USING AN AFOCAL BEAM ADJUSTMENT ASSEMBLY

(71) Applicant: CORNING INCORPORATED, CORNING, NY (US)

(72) Inventor: Duc Anh Bui, Krailling (DE)

(21) Appl. No.: 16/111,766

(22) Filed: Aug. 24, 2018

Related U.S. Application Data
(60) Provisional application No. 62/550,033, filed on Aug. 25, 2017.

(51) Int. Cl. C03B 33/09; B23K 26/364; B23K 26/06

(52) U.S. Cl. CPC C03B 33/091; B23K 2103/54; B23K 26/0665; B23K 26/364

(57) ABSTRACT

A method for laser processing a transparent workpiece includes forming a contour line in the transparent workpiece and directing an infrared laser beam output by an infrared beam source through an a focal beam adjustment assembly and onto the transparent workpiece along the contour line to separate the transparent workpiece along the contour line. The infrared laser beam forms an annular infrared beam spot on a surface of the transparent workpiece. The infrared laser beam includes an entrance beam diameter upstream the afocal beam adjustment assembly and an exit beam diameter downstream the afocal beam adjustment assembly. The annular infrared beam spot includes an inner diameter, an outer diameter, and an annular thickness. Further, the focal beam adjustment assembly includes one or more adjustable optical elements. Moreover, adjusting the one or more adjustable optical elements alters the exit beam diameter, thereby altering the annular thickness of the annular infrared beam spot.

This application claims the benefit of priority under 35 U.S.C. § 119 of U.S. Provisional Application Ser. No. 62/550,033, filed on Aug. 25, 2017, the content of which is relied upon and incorporated herein by reference in its entirety

### BACKGROUND

### Field

The present specification generally relates to apparatuses and methods for laser processing transparent workpieces, and more particularly, to separating transparent workpieces.

### Technical Background

The area of laser processing of materials encompasses a wide variety of applications that involve cutting, drilling, milling, welding, melting, etc. of different types of materials. Among these processes, one that is of particular interest is cutting or separating different types of transparent substrates in a process that may be utilized in the production of materials such as glass, sapphire, or fused silica for thin film transistors (TFT) or display materials for electronic devices.

From process development and cost perspectives there are many opportunities for improvement in cutting and separating glass substrates. It is of great interest to have a faster, cleaner, cheaper, more repeatable and more reliable method of separating glass substrates than what is currently practiced in the market. Accordingly, a need exists for alternative improved methods for separating glass substrates.

### SUMMARY

According to one embodiment, a method for laser processing a transparent workpiece includes forming a contour line in the transparent workpiece, which includes defects in the transparent workpiece, and directing an infrared laser beam output by an infrared beam source through an afocal beam adjustment assembly and onto the transparent workpiece along or near the contour line to separate the transparent workpiece along the contour line. The infrared laser beam forms an annular infrared beam spot on a surface of the transparent workpiece. The infrared laser beam includes an entrance beam diameter upstream the afocal beam adjustment assembly and an exit beam diameter downstream the afocal beam adjustment assembly. The annular infrared beam spot includes an inner diameter, an outer diameter, and an annular thickness. Further, the focal beam adjustment assembly includes one or more adjustable optical elements. Moreover, adjusting at least one of the one or more adjustable optical elements alters the exit beam diameter of the infrared laser beam, thereby altering the annular thickness of the annular infrared beam spot formed on the surface of the transparent workpiece.

In another embodiment, a method for laser processing a transparent workpiece includes focusing a pulsed laser beam into a pulsed laser beam focal line directed into the transparent workpiece, the pulsed laser beam focal line producing a defect within the transparent workpiece, translating the transparent workpiece and the pulsed laser beam focal line relative to each other thereby laser forming a plurality of defects along a contour line within the transparent workpiece, and directing an infrared laser beam through an afocal beam adjustment assembly and onto the transparent workpiece along or near the contour line to separate the transparent workpiece along the contour line. The infrared laser beam forms an annular infrared beam spot on a surface of the transparent workpiece. The annular infrared beam spot includes an inner diameter, an outer diameter, and an annular thickness. Further, the afocal beam adjustment assembly includes one or more adjustable optical elements configured to adjust a beam diameter of the infrared laser beam and thereby alter the annular thickness of the annular infrared beam spot formed on the surface of the transparent workpiece.

In yet another embodiment, and optical assembly includes an infrared beam source configured to output an infrared laser beam, an axicon lens positioned downstream the infrared beam source, a first plano-convex lens positioned downstream the axicon lens, and a second plano-convex lens positioned downstream the first plano-convex lens. When the infrared laser beam traverses each of the axicon lens, the first plano-convex lens, and the second plano-convex lens and thereafter irradiates a transparent workpiece positioned downstream the second plano-convex lens, the infrared laser beam forms an annular infrared beam spot including an inner diameter, an outer diameter, and an annular thickness on a surface of the transparent workpiece. The optical assembly further includes an afocal beam adjustment assembly positioned between the infrared beam source and the first plano-convex lens. The afocal beam adjustment assembly includes one or more adjustable optical elements and adjusting at least one of the one or more adjustable optical elements alters the annular thickness of the annular infrared beam spot formed on the surface of the transparent workpiece.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an annular infrared beam spot traversing a contour line formed in a transparent workpiece, according to one or more embodiments described herein;

FIG. 2 graphically depicts the cross-sectional power distribution of an embodiment of an annular infrared laser beam, according to one or more embodiments described herein;

FIG. 3A schematically depicts an optical assembly utilized to form an annular infrared beam spot, according to one or more embodiments described herein;

FIG. 3B schematically depicts an optical assembly utilized to form an annular infrared beam spot that includes an afocal beam adjuster positioned upstream an axicon lens, according to one or more embodiments shown and described herein;

FIG. 3C schematically depicts an optical assembly utilized to form an annular infrared beam spot that includes an afocal beam adjuster positioned downstream an axicon lens, according to one or more embodiments shown and described herein;

FIG. 4A schematically depicts an afocal beam adjustor comprising an intermediate concave lens positioned between a first convex lens and a second convex lens, where the afocal beam adjustor is positioned in a beam expanding mode, according to one or more embodiments shown and described herein;

FIG. 4B schematically depicts the afocal beam adjustor of FIG. 4B positioned in a beam neutral mode, according to one or more embodiments shown and described herein;

FIG. 4C schematically depicts the afocal beam adjustor of FIGS. 4A and 4B positioned in a beam narrowing mode, according to one or more embodiments shown and described herein;

FIG. 5 schematically depicts another embodiment of the afocal beam adjustor, according to one or more embodiments shown and described herein;

FIG. 6 schematically depicts example annular infrared beam spots irradiating a transparent workpiece having zones of interest, according to one or more embodiments shown and described herein;

FIGS. 7A graphically depicts the beam diameter of the infrared laser beam as a function of suitable power for a conventional Gaussian infrared laser beam laser profile, according to one or more embodiments described herein;

FIG. 7B graphically depicts the beam diameter of the infrared laser beam as a function of suitable power for an annular infrared beam spot, according to one or more embodiments described herein;

FIG. 8 depicts an image of the side of a separated transparent workpiece at the point of separation, and shows cracks caused by excessive heating by a conventional laser treatment utilizing a Gaussian infrared laser beam at the contour line, according to one or more embodiments described herein.

FIG. 9 schematically depicts the formation of a contour line of line defects according to one or more embodiments described herein;

FIG. 10 schematically depicts the positioning of a pulsed laser beam focal line during processing of a transparent workpiece, according to one or more embodiments described herein;

FIG. 11A schematically depicts an optical assembly for pulsed laser processing, according to one embodiment according to one or more embodiments described herein;

FIG. 11B-1 schematically depicts a first embodiment of a pulsed laser focal line in relationship to a transparent workpiece, according to one or more embodiments described herein;

FIG. 11B-2 schematically depicts a second embodiment of a pulsed laser focal line in relationship to a transparent workpiece, according to one or more embodiments described herein;

FIG. 11B-3 schematically depicts a third embodiment of a pulsed laser focal line in relationship to a transparent workpiece, according to one or more embodiments described herein;

FIG. 11B-4 schematically depicts a fourth embodiment of a pulsed laser focal line in relationship to a transparent workpiece, according to one or more embodiments described herein;

FIG. 12 schematically depicts another embodiment of an optical assembly for pulsed laser processing, according to one or more embodiments described herein;

FIGS. 13A schematically depicts another embodiment of an optical assembly for pulsed laser processing, according to one or more embodiments described herein;

FIG. 13B schematically depicts a detailed view of the pulsed laser of FIG. 10A at the transparent workpiece, according to one or more embodiments described herein;

FIG. 14 schematically depicts another embodiment of an optical assembly for pulsed laser processing, according to one or more embodiments described herein;

FIGS. 15A schematically depicts an intensity regime for an unfocused pulsed laser beam, according to one or more embodiments described herein;

FIG. 15B schematically depicts an intensity regime for a condensed pulsed laser beam with a spherical lens, according to one or more embodiments described herein;

FIG. 15C schematically depicts an intensity regime for a condensed pulsed laser beam with an axicon or diffractive Fresnel lens, according to one or more embodiments described herein;

FIG. 16A graphically depicts the relative intensity of laser pulses within an exemplary pulse burst vs. time, with each exemplary pulse burst having 7 pulses, according to one or more embodiments described herein; and

FIG. 16B graphically depicts relative intensity of laser pulses vs. time within an exemplary pulse burst, with each exemplary pulse burst containing 9 pulses, according to one or more embodiments described herein.

### DETAILED DESCRIPTION

Reference will now be made in detail to embodiments of processes for laser processing transparent workpieces, such as glass workpieces, examples of which are illustrated in the accompanying drawings. Whenever possible, the same reference numerals will be used throughout the drawings to refer to the same or like parts. According to one or more embodiments described herein, a transparent workpiece may be laser processed to separate the transparent workpiece into two or more portions. Generally, the process involves at least a first step of forming a contour line comprising defects in the transparent workpiece, and a second step of separating the transparent workpiece along the contour line by subjecting the transparent workpiece to an infrared laser beam at or near the contour line. According to one embodiment, a pulsed laser beam may be utilized to create a series of line defects in the transparent workpiece thereby defining the contour line. These line defects may be referred to herein as perforations or nano-perforations in the transparent workpiece. The infrared laser may then be utilized to heat the area of the transparent workpiece adjacent to the contour line to separate the transparent workpiece at the contour line. Separation along the contour line may be caused by mechanical stresses in the transparent workpiece caused by differences in the temperature of the transparent workpiece at its different portions caused by the heating from the infrared laser beam. Various embodiments of methods and apparatuses for separating a transparent workpiece will be described herein with specific reference to the appended drawings.

The phrase “transparent workpiece,” as used herein, means a workpiece formed from glass or glass-ceramic which are transparent, where the term “transparent,” as used herein, means that the material has an optical absorption of less than about 10% per mm of material depth, such as less than about 1% per mm of material depth for the specified pulsed laser wavelength. According to some embodiments, at least a portion of the workpiece, such as the portion which is separated, has a coefficient of thermal expansion of less than about 5×10⁻⁶/K, such as less than about 4×10⁻⁶/K, or less than about 3.5×10⁻⁶/K. For example, the workpiece may have a coefficient of thermal expansion of about 3.2×10⁻⁶/K. The transparent workpiece may have a thickness of from about 50 microns to about 10 mm (such as from about 100 microns to about 5 mm, or from about 0.5 mm to about 3 mm.

The phrase “contour line,” as used herein, denotes a line (e.g., a line, a curve, etc.) of intended separation on the surface of a transparent workpiece along which the transparent workpiece will be separated into multiple portions upon exposure to the appropriate processing conditions. The contour line generally consists of one or more defects introduced into the transparent workpiece using various techniques. As used herein, a “defect” of “line defect” may include an area of modified material (relative to the bulk material), void space, scratch, flaw, hole, or other deformalities in the transparent workpiece which enables separation by an additional heat treatment, such as by infrared laser processing.

A transparent workpiece, such as a glass substrate or the like, may be separated into multiple portions by first forming a contour line on the surface of the workpiece and, thereafter, heating the surface of the workpiece on the contour line to create thermal stresses in the workpiece. The stresses ultimately lead to the spontaneous separation of the workpiece along the contour line. Heating the surface of the workpiece may be carried out, for example, using an infrared laser. Specifically, conventional infrared laser processing to induce separation along a contour line utilizes an infrared laser beam directed incident on the contour line with a profile which causes maximum heat intensity directly onto the defects defining the contour line. For example, a Gaussian beam profile may be conventionally utilized and centered directly on the contour line. In such conventional processes, the maximum intensity of laser energy, as well as heat, is at the contour line. However, it has been discovered that utilizing an infrared laser beam with a peak intensity on the contour line (which has sufficient energy to cause separation) may cause damage to the edges of the separated transparent workpieces where the contour line existed prior to separation. For example, for some glass compositions which require relatively high powered infrared lasers for separation, heat cracks may propagate from the separated edge in a direction generally perpendicular to the edge of the separated transparent workpiece (i.e., generally perpendicular to the intended line of separation denoted by the contour line) which weaken the edges of separated transparent workpiece.

Further, the spontaneous separation following heating of the contour line is related to the coefficient of thermal expansion (CTE) of the material of the transparent workpiece, with materials having relatively high CTEs being more amenable to spontaneous separation upon heating than materials with relatively low CTEs. In situations where the transparent workpiece is formed from a material having a relatively low CTE, spontaneous separation along the contour line may be facilitated by increasing the thermal energy imparted to the transparent workpiece. However, under certain conditions (e.g., when the CTE of the material is extremely low), by conventional means, it may not be possible to increase the thermal energy imparted to the transparent workpiece without damaging (e.g., melting) the workpiece, rendering the workpiece unviable.

For example, in some embodiments of conventional infrared laser processing, if the spot size is too small (e.g., less than 1 mm), or the CO₂ laser power is too high (e.g., greater than 400 W), the transparent workpiece may be over heated at the contour line, creating ablation, melting, and/or thermally generated cracks in the transparent workpiece, which are undesirable, as they will reduce the edge strength of the separated parts. Such parameters may be unavoidable under conventional processing by Gaussian beam profiles, particularly on transparent substrates such as glass with a relatively low CTE (e.g., less than about 4×10⁻⁶/K), these high intensity laser parameters may be necessary to cause separation of the transparent workpiece by crack propagation along the contour line when a Gaussian laser profile is utilized. Thus, by conventional means, it may be challenging or even unavoidable to separate low CTE glass workpieces without causing undesirable effects such as ablation, melting, and/or thermally generated cracking.

The above-described deficiencies of conventional infrared laser processing may be overcome by utilizing an infrared laser beam profile which has a greater distribution of cumulated energy from the infrared laser beam located in areas adjacent to the contour line than directly on the contour line. That is, the infrared laser beam may transfer more energy onto areas adjacent to the contour line than directly onto the contour line. As used herein, “cumulated energy” refers to all energy transferred onto a particular area of a workpiece by the infrared laser beam as the laser beam is translated with respect to the workpiece. For example, in one embodiment, the infrared laser separation may utilize an annular laser beam that forms an annular infrared beam spot on the transparent workpiece. For example, the annular infrared beam spot may be centered on the contour line but project greater amounts of energy onto the areas adjacent to the contour line than directly onto the contour line. With such a beam profile, greater total amounts of thermal energy may be applied to the transparent workpiece without causing heat cracks and/or melting due to overheating at the contour line.

Further, in some embodiments, it may be desirable to alter the annular thickness of the annular infrared beam spot (i.e. the difference between an outer diameter and an inner diameter of the annular infrared beam spot). For example, it may be desirable to increase the annular thickness of the annular infrared beam spot when the laser power of the infrared laser beam is increased because increased laser power may damage the transparent workpiece 130. Increasing laser power may be useful when the relative translation speed of the annular infrared beam spot 210 and the transparent workpiece 130 is increased, thereby decreasing the time required to separate the transparent workpiece. Increasing laser power may also be useful when separating transparent workpieces having a low CTE, such as CORNING LOTUS™ and CORNING SAPPHIRE™, each available from Corning Incorporated of Corning, N.Y. While not intending to be limited by theory, a transparent workpiece 130 comprising a lower CTE requires a more laser power to release than a transparent workpiece 130 having a higher CTE. To compensate for this increase in laser power, increasing the annular thickness of the annular infrared beam spot may spread the increased laser power applied by the infrared laser beam onto the transparent workpiece 130 over a greater surface area of the transparent workpiece 130, thereby reducing the local laser power applied to each discrete surface portion of the transparent workpiece 130 interacting (i.e. via irradiation) with the annular infrared beam spot 210, limiting damage. Thus, optical assemblies for forming the annular infrared beam spot are described herein that include an afocal beam adjustment assembly for altering the annular thickness of the afocal beam adjustment assembly.

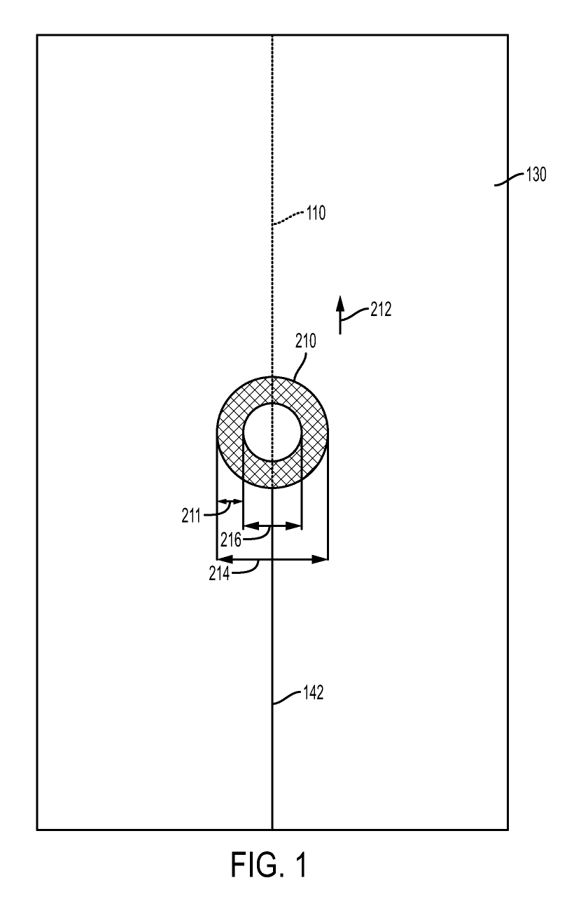

Referring now to FIG. 1 by way of example, a transparent workpiece 130, such as a glass workpiece or a glass-ceramic workpiece, is schematically depicted undergoing separation according to the methods described herein. Initially, a contour line 110 is formed in a surface of the transparent workpiece 130 to delineate the line of intended separation about which the transparent workpiece 130 will be separated into two or more portions. The contour line 110 may be outlined by a series of defects in the transparent workpiece 130. While the contour line 110 is depicted in FIG. 1 as being substantially linear, it should be understood that other configurations are contemplated and possible including, without limitation, curves, patterns, regular geometric shapes, irregular shapes, and the like. As noted herein, the contour line 110 includes defects which may be further acted upon to induce spontaneous separation of the transparent workpiece 130 along the contour line 110.

According to embodiments, the defects of the contour line 110 may be formed by a number of methods, including laser processing, mechanical processing, or combinations thereof. For example, the contour line 110 may be formed by laser scribing or mechanical scoring. In one embodiment, a silicon carbide wheel or scribing tool or a diamond-tipped scribing tool may be used to form the contour line 110 and the defects contained therein. In another embodiment, a laser processing technique may be utilized to form the defects of the contour line 110 in the transparent workpiece 130. For example, in embodiments, the methods and apparatuses for forming a “perforated” contour line as disclosed in U.S. Patent Application Publication No. 2015/0360991, published Dec. 17, 2015 and incorporated herein by reference in its entirety, may be used to form the contour line 110 in the transparent workpiece 130.

According to the methods described in U.S. Patent Application Publication No. 2015/0360991, the contour line 110 may comprise line shaped defects, referred to herein as “line defects,” that extend into the surface of the transparent workpiece 130 and delineate the desired shape of the separated workpiece and establish a path for crack propagation and, hence, separation of the shape the transparent workpiece 130 into separate portions along the contour line 110. To form the contour line 110, the transparent workpiece 130 to be processed may be irradiated with an ultra-short pulsed (i.e., having a pulse width less than 100 psec) laser beam at wavelengths at or below 1064 nm that is condensed into a high aspect ratio line focus that penetrates through at least a portion of the thickness of the transparent workpiece 130. Within this volume of high energy density, the material of the transparent workpiece 130 along the contour line 110 is modified via nonlinear effects (e.g., by two photon absorption), specifically creating defects in the material of the transparent workpiece 130. By scanning the laser over a desired line or path, narrow line defects (e.g., a few microns wide) defining the contour line 110 may be formed. This contour line 110 may define the perimeter or shape to be separated from the transparent workpiece 130 in a subsequent heating step.

Still referring to FIG. 1, following the formation of the contour line 110 in the transparent workpiece 130, a thermal source, such as an infrared laser beam, may be utilized to separate the transparent workpiece 130 along the contour line 110. According to embodiments, the thermal source may be used to create thermal stress and thereby separate the transparent workpiece 130 at the contour line 110. In embodiments, an infrared laser beam may be used to initiate spontaneous separation and then the separation may be finished mechanically.

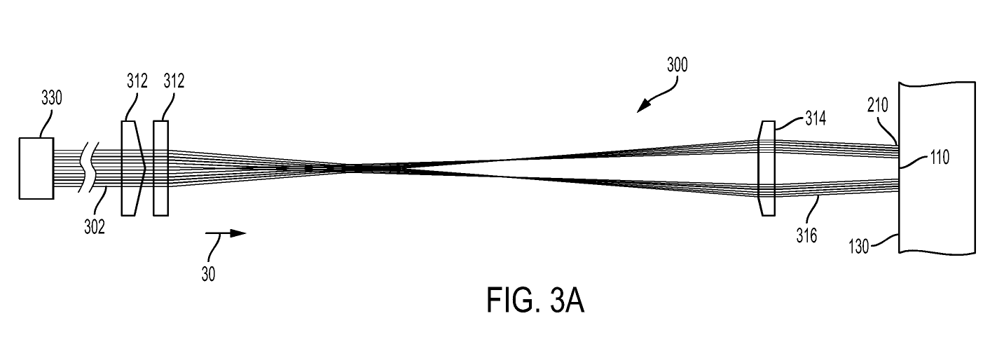

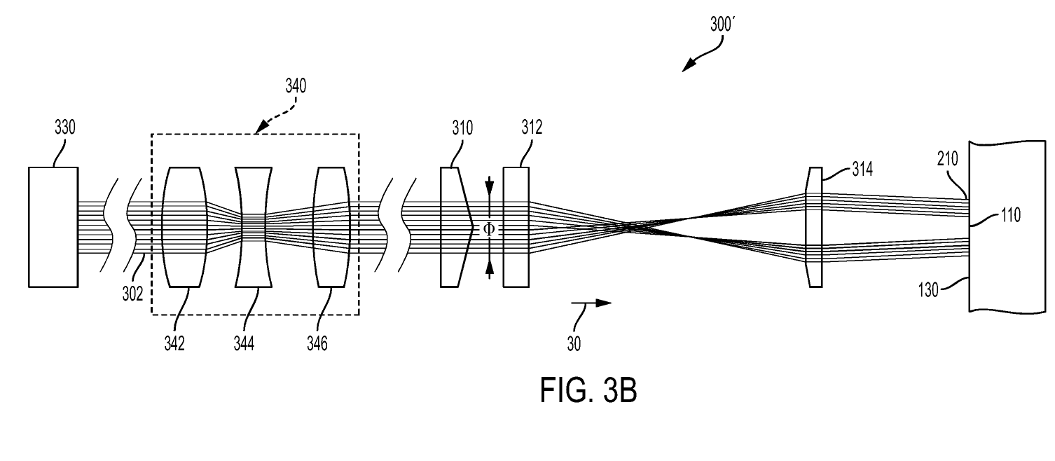

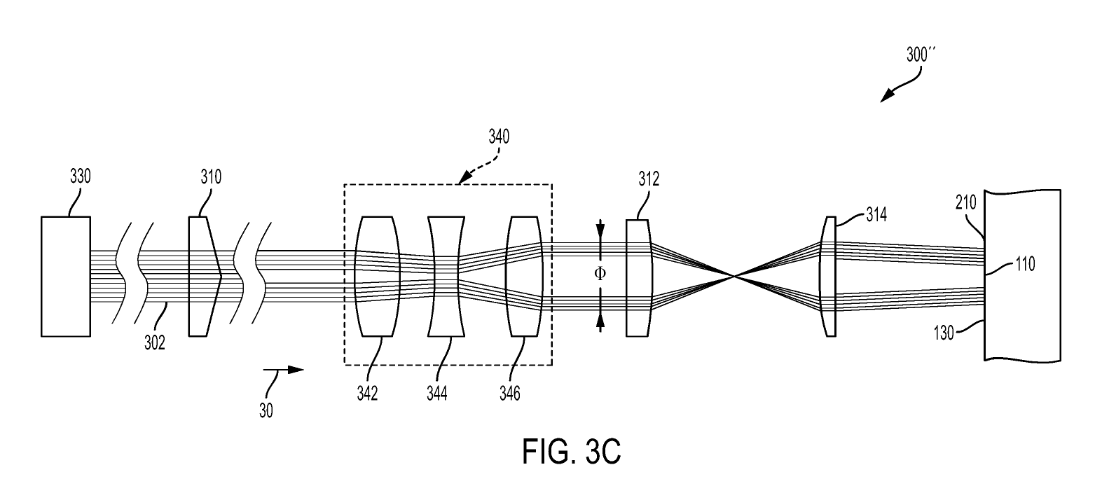

The infrared laser beam (i.e. infrared laser beam 302 of FIGS. 3A-3C), such as a laser beam produced by a carbon dioxide laser (a “CO₂ laser”), a carbon monoxide laser (a “CO laser”), a solid state laser, a laser diode, or combinations thereof, is a controlled heat source that rapidly increases the temperature of the transparent workpiece 130 at or near the contour line 110. This rapid heating may build compressive stress in the transparent workpiece 130 on or adjacent to the contour line 110. Since the area of the heated glass surface is relatively small compared to the overall surface area of the transparent workpiece 130, the heated area cools relatively rapidly. The resultant temperature gradient induces tensile stress in the transparent workpiece 130 sufficient to propagate a crack along the contour line 110 and through the thickness of the transparent workpiece 130, resulting in full separation of the transparent workpiece 130 along the contour line 110. Without being bound by theory, it is believed that the tensile stress may be caused by expansion of the glass (i.e., changed density) in portions of the workpiece with higher local temperature.

Still referring to FIG. 1, in the embodiments described herein, the infrared laser beam (with an annular infrared beam spot 210 projected onto the transparent workpiece 130) may be directed onto the transparent workpiece 130 and translated relative to the transparent workpiece 130 along the contour line 110 in a processing direction 212. It should be understood that the “annular infrared beam spot 210” may in some cases be referred to interchangeably with the infrared laser beam 302 of FIGS. 3A-3C, as the annular infrared beam spot 210 is formed on the area of the transparent workpiece 130 contacted by the infrared laser beam 302. Separated portion 142 of the contour line 110 is formed by heating the contour line 110 with the infrared laser beam (e.g., by traversing the annular infrared beam spot 210), thereby causing a crack to propagate along the contour line 110 and through its thickness causing spontaneous separation to occur. The separated portion 142 of the contour line 110 trails the annular infrared beam spot 210 as it moves in the processing direction 212. According to one or more embodiments, the infrared laser beam may be translated across the transparent workpiece 130 by motion of the transparent workpiece 130, motion of the infrared laser beam (i.e., motion of the annular infrared beam spot 210), or motion of both the transparent workpiece 130 and the infrared laser beam. By translating the annular infrared beam spot 210 relative to the transparent workpiece 130, the transparent workpiece 130 may be separated along the contour line 110 containing defects.

According to embodiments described herein, the annular infrared beam spot 210 may be projected at or near the contour line 110 and transfer a greater amount of energy onto the areas of the transparent workpiece 130 adjacent to both sides of the contour line 110 than directly onto the contour line 110. The areas “adjacent” to the contour line 110 include any areas of the transparent workpiece 130 on both sides of the contour line 110 (i.e., any area which does not include the line of defects). Heating the transparent workpiece 130 on both sides of the contour line 110 creates the thermal stress to facilitate spontaneous separation of the transparent workpiece 130 along the contour line 110. However, while the total amount of energy imparted to the transparent workpiece 130 to facilitate spontaneous separation along the contour line 110 may be the same as if the infrared laser beam was focused with maximum intensity directly on the contour line 110 (e.g., a Gaussian beam profile), heating the transparent workpiece 130 on both sides of the contour line 110 rather than with maximum intensity directly on the contour line 110 spreads the total amount of thermal energy over a larger area, thereby mitigating the formation of cracks lateral to the contour line 110 due to overheating and also reducing or even mitigating melting of the material of the transparent workpiece 130 adjacent to or at the contour line 110. Indeed, heating the transparent workpiece 130 with maximum intensity on both sides of the contour line 110 rather than with maximum intensity directly on the contour line 110 may actually allow for a greater amount of total thermal energy to be introduced into the transparent workpiece 130 without the formation of undesired lateral cracks and/or melting, thereby enabling laser separation of transparent workpieces 130 formed from materials having relatively low CTEs.

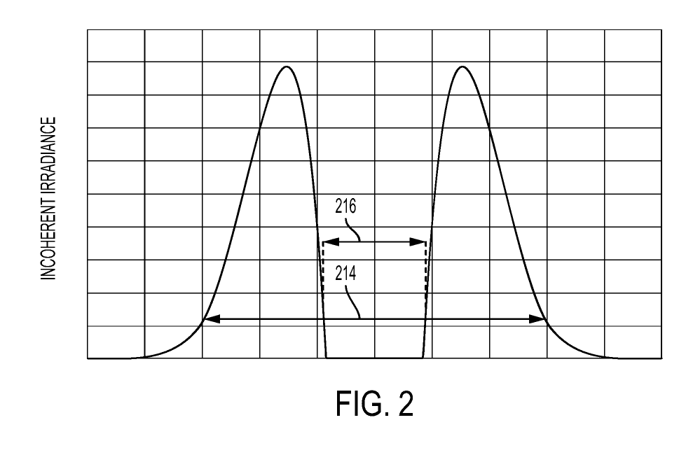

In some embodiments, the infrared laser beam used to facilitate spontaneous separation may comprise an annular beam profile, such as the circular symmetric annular beam profile depicted in FIG. 1 (i.e. the annular infrared beam spot 210), in order to transfer a greater amount of energy onto the areas adjacent the contour line 110 than directly onto the contour line 110. FIG. 2, graphically depicts the energy distribution of the annular beam as a function of beam diameter. As used herein, an annular beam profile refers to any laser beam profile which generally has a maximum intensity away from the center of the beam and has an intensity trough at its center relative to the maximum intensity. The trough may include complete lack of energy at the center of the beam, such as shown in the example beam profile of FIG. 2 (i.e. the intensity of the beam is 0 at its center). While reference has been made herein to the use of an annular infrared beam spot 210 which is circular symmetric relative to the contour line 110 to facilitate heating the transparent workpiece 130 on both sides of the contour line 110, it should be understood that other configurations of beams are contemplated and possible so long as the beam has a profile in which the maximum intensity is not concentric with the center of the beam.

As depicted in FIG. 1, the infrared laser beam may be centered on the contour line 110 (forming the annular infrared beam spot 210 thereon) such that equal amounts of thermal energy are projected onto each side of the contour line 110. In such an embodiment, the annular infrared beam spot 210 will transfer more thermal energy onto adjacent areas on both sides of the contour line 110 than directly onto the contour line 110. It should be understood that the annular infrared beam spot 210 of FIG. 1 is schematic in nature, and is one representation of an annular beam profile such as that depicted in FIG. 2. A separation process which utilizes an infrared laser beam which projects its maximum power away from the contour line 110 may allow for more total power to be imparted to the transparent workpiece without causing damage to the separated surfaces and/or edges from excessive localized heating. The additional power may cause more thermal stress within the transparent workpiece, which may enable separation of low CTE materials, thicker workpieces, and/or stacks of workpieces without damaging the workpieces.

The annular infrared beam spot 210 may comprise an inner diameter 216, an outer diameter 214, and an annular thickness 211. According to embodiments, the inner diameter 216 is defined as twice the distance (i.e., a radius) where 86% of the beam energy is outside of that distance from the center of the beam (i.e. from the center of the annular infrared beam spot 210). Similarly, the outer diameter 214 is defined as twice the distance (i.e., a radius) where 86% of the beam energy is inside of that distance from the beam center. Further, the annular thickness 211 is the difference between the outer diameter 214 and the inner diameter 216. According to embodiments, the outer diameter 214 may be from about 0.5 mm to about 20 mm, such as from about 1 mm to about 10 mm, from about 2 mm to about 8 mm, or from about 3 mm to about 6 mm. The inner diameter 216 may be from about 0.01 mm to about 10 mm, from about 0.1 mm to about 10 mm, or from about 0.7 mm to about 3 mm. For example, the inner diameter 216 may be from about 5% to about 95% of the outer diameter 214, such as from about 10% to about 50%, from about 20% to about 45%, or from about 30% to about 40% of the outer diameter 214. Further, the annular thickness 211 may be from about 0.04 mm to about 19.99 mm for example, about 0.1 mm, 0.5 mm, 0.75 mm, 1 mm, 1.5 mm, 2 mm, 2.5 mm, 3 mm, 3.5 mm, 4 mm, 4.5 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or the like, for example, from about 1 mm to about 9 mm. According to some embodiments, the maximum power from the annular infrared beam spot 210 (as well as maximum temperature in the transparent workpiece 130) may be at a distance from the contour line 110 about equal to about the half the inner diameter 216.

Referring now to FIG. 3A, an optical assembly 300 is depicted for producing an annular infrared beam spot 210 on the transparent workpiece 130. The optical assembly 300 comprises an infrared beam source 330 for generating an infrared laser beam 302, which may be a Gaussian beam. The infrared beam source 330 may comprise, for example, a CO₂ laser, a CO laser, a solid state laser, a laser diode, or the like. In operation, the infrared beam source 330 may generate and emit the infrared laser beam 302 which propagates from the infrared beam source 330 toward the transparent workpiece 130 in an infrared beam propagation direction 30. According to one or more embodiments, the infrared laser beam 302 output by the infrared beam source 330 may have a diameter of from about 8 mm to about 10 mm (according to its 1/e² diameter). As described in more detail below, this diameter may be altered using an afocal beam adjustment assembly positioned between the infrared beam source 330 and the transparent workpiece 130.

The first plano-convex lens 312 and the second plano-convex lens 314 are positioned downstream from the axicon lens 310 such that the infrared laser beam 302 output by the infrared beam source 330 is directed through the axicon lens 310 and, thereafter, through the first plano-convex lens 312 and the second plano-convex lens 314. As used herein “upstream” and “downstream” refer to the relative position of two locations or components of an optical assembly (e.g., the optical assembly 300) with respect to a beam source (e.g., the infrared beam source 330). For example, a first component is upstream from a second component if the beam output by the beam source traverses the first component before traversing the second component. Further, a first component is downstream from a second component if the beam output by the beam source traverses the second component before traversing the first component.

In operation, the infrared laser beam 302 may be directed through the axicon lens 310 and, thereafter, the first plano-convex lens 312 and the second plano-convex lens 314. In some embodiments, the first plano-convex lens 312 may have a focal length of from about 50 mm to about 200 mm (such as from about 50 mm to about 150 mm, or from about 75 mm to about 100 mm), and the second plano-convex lens 314 may have a focal length less than that of the first plano-convex lens, such as from about 25 mm to about 50 mm. The axicon lens 310 may have a conical surface having an angle of about 1.2°, such as from about 0.5° to about 5°, or from about 1° to about 1.5°, or even from about 0.5° to about 5° (the angle measured relative to the flat surface upon which the beam enters the axicon lens 310. The axicon lens 310 shapes the incoming infrared laser beam 302 (which comprises a Gaussian beam) into a Bessel beam which, in turn, is directed through the first plano-convex lens 312 and the second plano-convex lens 314. The first plano-convex lens 312 and second plano convex lens 314 collimate the Bessel beam and adjust the diameter(s) of the annular spot of the Bessel beam (i.e. the annular infrared beam spot 210). In particular, the first plano-convex lens 312 may shape the infrared laser beam 302 (which comprises a Bessel beam downstream the axicon lens 310) into an annular beam profile and the second plano-convex lens 314 may focus the infrared laser beam 302 (which comprises an Bessel beam with an annular beam profile downstream the first plano-convex lens 312) onto the transparent workpiece 130 forming the annular infrared beam spot 210 thereon (e.g., along or near the contour line 110, as shown in FIG. 1).

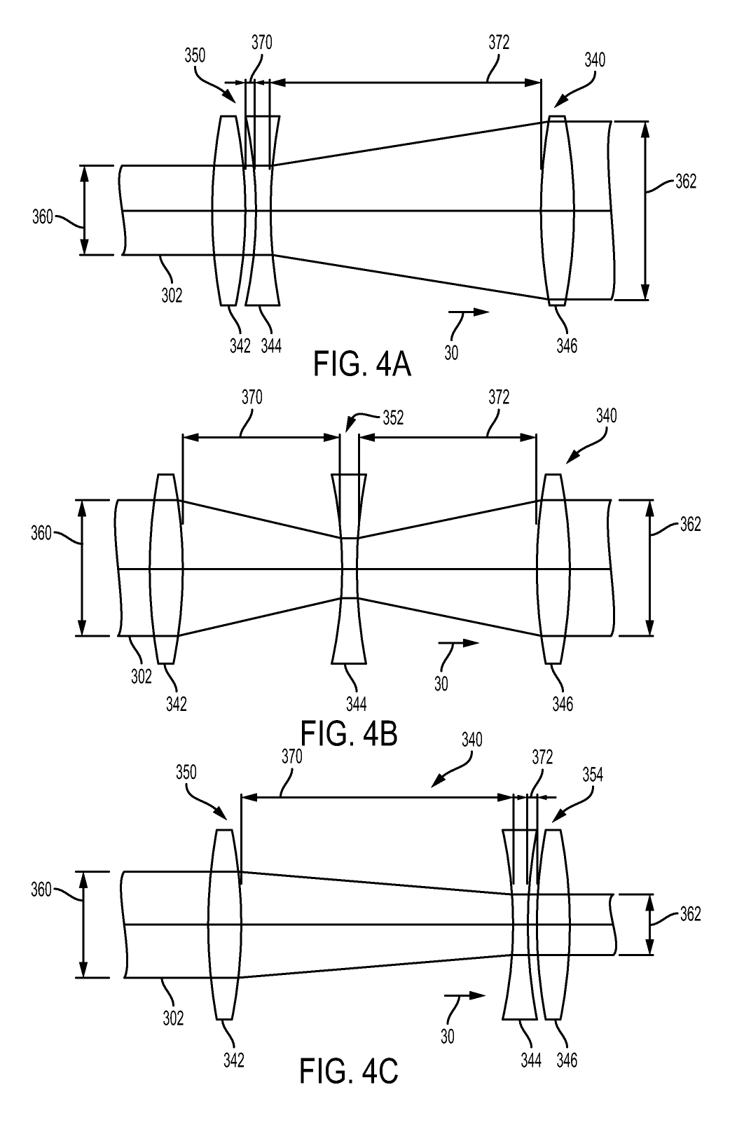

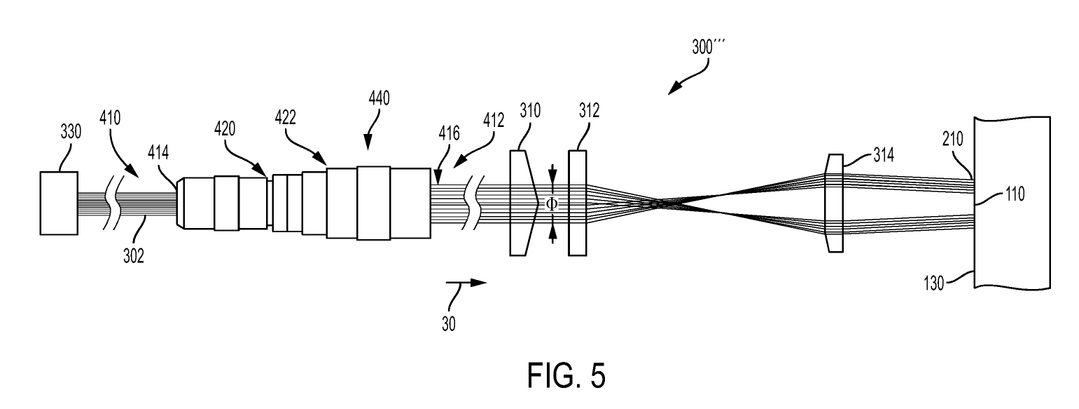

As depicted in FIG. 1, the annular thickness 211, the inner diameter 216 and the outer diameter 214 of the annular infrared beam spot 210 may each be controlled and altered by the components of the optical assembly 300. In particular, the annular thickness 211 of the annular infrared beam spot 210 (i.e. the difference between the outer diameter 214 and the inner diameter 216) is mathematically defined as 0.5 Φf₂/f_{1′}, where Φ is the diameter of the infrared laser beam 302 upon entrance into the first plano-convex lens 312 (hereinafter “beam diameter Φ”), f₁ is the focal length of the first plano-convex lens 312 and f₂ is the focal length of the second plano-convex lens 314. As the focal length f₁ of the first plano-convex lens 312 and the focal length f₂ of the second plano-convex lens 314 are fixed, the annular thickness 211 of the annular infrared beam spot 210 may be adjusted by adjusting the beam diameter Φ, for example, using an afocal beam adjustment assembly positioned upstream the first plano-convex lens 312 that provides selective adjustability of the beam diameter Φ of the infrared laser beam 302, such as an afocal beam adjustment assembly 340 (FIGS. 3B and 3C-4C), an afocal beam adjustment assembly 440 (FIG. 5), or any other afocal optical element(s) configured to provide selective beam diameter adjustability, such as a motorized modal zoom adaptor.

While not intending to be limited by theory, the relative positioning of the second plano-convex lens 314 and the transparent workpiece 130 affects the size of both the inner diameter 216 and the outer diameter 214 of the annular infrared beam spot 210 synchronously such that changing the relative positioning of the transparent workpiece 130 and the second plano-convex lens 314 changes the inner diameter 216 and the outer diameter 214 by the same amount. For example, when the transparent workpiece 130 is moved closer to a location spaced from the second plano-convex lens 314 a distance equal to the focal length of the second plano-convex lens 314, the inner diameter 216 and the outer diameter 214 each decrease and when the transparent workpiece 130 is moved farther from a location spaced from the second plano-convex lens 314 a distance equal to the focal length of the second plano-convex lens 314, the inner diameter 216 and the outer diameter 214 each increase.

While also not intending to be limited by theory, the afocal optical beam adjustment assemblies described herein are configured to alter the size of the inner diameter 216 without altering the size of the outer diameter 214, thereby altering the annular thickness 211 of the annular infrared beam spot 210. In particular, the afocal beam adjustment assemblies described herein each comprise one or more adjustable optical elements and in operation, adjusting at least one of the one or more adjustable optical elements alters the beam diameter of the infrared laser beam downstream the afocal beam adjustment assembly (i.e. the exit beam diameter), thereby altering the annular thickness of the annular infrared beam spot formed on the surface of the transparent workpiece.

Referring now to FIG. 3B and 3C, optical assemblies 300′ (FIG. 3B) and 300″ (FIG. 3C) are depicted. The optical assemblies 300′ and 300″ each comprise the infrared beam source 330, the axicon lens 310, the first plano-convex lens 312, and the second plano-convex lens 314 of the optical assembly 300, as well as the afocal beam adjustment assembly 340. In the embodiment depicted in FIG. 3B (i.e. optical assembly 300′), the afocal beam adjustment assembly 340 is positioned upstream the axicon lens 310 such that the afocal beam adjustment assembly 340 may alter the beam diameter of the infrared laser beam 302 before the infrared laser beam 302 traverses the axicon lens 310. In the embodiment depicted in FIG. 3C (i.e. optical assembly 300″), the afocal beam adjustment assembly 340 is positioned downstream the axicon lens 310 such that the afocal beam adjustment assembly 340 may alter the beam diameter of the infrared laser beam 302 after the infrared laser beam 302 traverses the axicon lens 310.

The afocal beam adjustment assembly 340 comprises a first convex lens 342, a second convex lens 346, and an intermediate concave lens 344 positioned between and optically coupled to the first convex lens 342 and the second convex lens 346. The first convex lens 342 is positioned upstream the second convex lens 346 such that the infrared laser beam 302 first traverses the first convex lens 342, then traverses the intermediate concave lens 344 and thereafter traverses the second convex lens 346. The first and second convex lenses 342, 346 each comprise convex lenses, for example, biconvex lenses, plano-convex lenses, or the like and the intermediate concave lens 344 comprises a concave lens, such as a biconcave lens, a plano-concave lens, or the like. Further, the first convex lens 342 and the second convex lens 346 may comprise equal focal lengths. In operation, the first convex lens 342 focuses the infrared laser beam 302, the intermediate concave lens 344 expands the infrared laser beam 302, and the second convex lens 346 collimates the infrared laser beam 302. Further, as described in more detail below, the relative positioning of each of the first convex lens 342, the second convex lens 346, and the intermediate concave lens 344 may be adjustable (i.e. one or more of the first convex lens 342, the second convex lens 346, and the intermediate concave lens 344 may comprise adjustable optical elements) and adjusting the relative positioning of these components may alter the annular thickness 211 of the annular infrared beam spot 210 formed on the transparent workpiece 130.

Referring now to FIGS. 4A-4C, the afocal beam adjustment assembly 340 is depicted in more detail. As shown in FIGS. 4A-4C, the intermediate concave lens 344 is translatable relative to the first convex lens 342 and the second convex lens 346 such that the relative positioning between the lenses of the afocal beam adjustment assembly 340 may expand the beam diameter, narrow the beam diameter, or leave the beam diameter unaffected. In other words, the relative positioning of the intermediate concave lens 344 and the first convex lens 342 and the second convex lens 346, respectively, may position the afocal beam adjustment assembly 340 in a beam expanding mode 350 (FIG. 4A), a beam neutral mode 352 (FIG. 4B), or a beam narrowing mode 354 (FIG. 4C). Further, the intermediate concave lens 344 and the first convex lens 342 are spaced apart by a first spacing distance 370 and the intermediate concave lens 344 and the second convex lens 346 are spaced apart by a second spacing distance 372.

In operation, the infrared laser beam 302 narrows along the first spacing distance 370 (i.e. narrowing the beam diameter) and the infrared laser beam 302 expands along the second spacing distance 372 (i.e. expanding the beam diameter). Moreover, in the embodiments depicted in FIGS. 4A-4C, the focal length of the first convex lens 342 and the second convex lens 346 may be twice the focal length of the intermediate concave lens 344 such that when the intermediate concave lens 344 is positioned halfway between the first convex lens 342 and the second convex lens 346, the beam diameter is the same at the entrance of the afocal beam adjustment assembly 340 and at the exit of the afocal beam adjustment assembly 340. In this embodiment, the infrared laser beam 302 focuses between the first convex lens 342 and the intermediate concave lens 344 at the same rate that the infrared laser beam 302 expands between the intermediate concave lens 344 and the second convex lens 346. For example, the first convex lens 342 and the second convex lens 346 may each comprise a focal length of about 100 mm and the intermediate concave lens 344 may comprise a focal length of about 50 mm. However, in other embodiments, the intermediate concave lens 344 may comprise a focal length that is not half the focal length of the first convex lens 342 and the second convex lens 346. In these embodiments, the relative positioning between each of the first convex lens 342, the second convex lens 346, and the intermediate concave lens 344 may be different than the depicted positions of FIGS. 4A-4C in each of the beam expanding mode 350, the beam neutral mode 352, and the beam narrowing mode 354.

Referring now to FIG. 4A, in the beam expanding mode 350, the first convex lens 342, the second convex lens 346, and the intermediate concave lens 344 are positioned relative to one another such that the beam diameter upstream the afocal beam adjustment assembly 340 (entrance beam diameter 360) is smaller than the beam diameter downstream the afocal beam adjustment assembly 340 (exit beam diameter 362). For example, in the embodiment depicted in FIG. 4A, the first spacing distance 370 is less than the second spacing distance 372 (i.e. the intermediate concave lens 344 is nearer the first convex lens 342 than the second convex lens 346). As the infrared laser beam 302 focuses between the first convex lens 342 and the intermediate concave lens 344 at same rate that the infrared laser beam 302 expands between the intermediate concave lens 344 and the second convex lens 346 in the embodiments of FIGS. 4A-4C, the infrared laser beam 302 expands over a greater distance than the infrared laser beam 302 focuses. Thus, the beam diameter upstream the afocal beam adjustment assembly 340 (entrance beam diameter 360) is smaller than the beam diameter downstream the afocal beam adjustment assembly 340 (exit beam diameter 362).

Referring now to FIG. 4B, in the beam neutral mode 352, the first convex lens 342, the second convex lens 346, and the intermediate concave lens 344 are positioned relative to one another such that the beam diameter upstream the afocal beam adjustment assembly 340 (entrance beam diameter 360) is the same as the beam diameter downstream the afocal beam adjustment assembly 340 (exit beam diameter 362). For example, in the embodiment depicted in FIG. 4B, the first spacing distance 370 is equal to the second spacing distance 372 (i.e. the intermediate concave lens 344 is equidistant the first convex lens 342 and the second convex lens 346). As the infrared laser beam 302 focuses between the first convex lens 342 at same rate that the infrared laser beam 302 expands between the intermediate concave lens 344 and the second convex lens 346 in the embodiments of FIGS. 4A-4C, the infrared laser beam 302 expands over the same distance as the infrared laser beam 302 focuses. Thus, the beam diameter upstream the afocal beam adjustment assembly 340 (entrance beam diameter 360) is equal the beam diameter downstream the afocal beam adjustment assembly 340 (exit beam diameter 362).

Referring now to FIG. 4C, in the beam narrowing mode 354, the first convex lens 342, the second convex lens 346, and the intermediate concave lens 344 are positioned relative to one another such that the beam diameter upstream the afocal beam adjustment assembly 340 (entrance beam diameter 360) is larger than the beam diameter downstream the afocal beam adjustment assembly 340 (exit beam diameter 362). For example, in the embodiment depicted in FIG. 4A, the first spacing distance 370 is greater than the second spacing distance 372 (i.e. the intermediate concave lens 344 is nearer the second convex lens 346 than the first convex lens 342). As the infrared laser beam 302 focuses between the first convex lens 342 at same rate that the infrared laser beam 302 expands between the intermediate concave lens 344 and the second convex lens 346 in the embodiments of FIGS. 4A-4C, the infrared laser beam 302 focuses over a greater distance than the infrared laser beam 302 expands. Thus, the beam diameter upstream the afocal beam adjustment assembly 340 (entrance beam diameter 360) is larger than the beam diameter downstream the afocal beam adjustment assembly 340 (exit beam diameter 362).

While FIGS. 4A-4C depict that the intermediate concave lens 344 is translatable between the first convex lens 342 and the second convex lens 346, it should be understood that each of the first convex lens 342, the intermediate concave lens 344, and the second convex lens 346 may be translatable relative to one another to alter the relative positioning of the first convex lens 342, the intermediate concave lens 344 and the second convex lens 346 and thereby alter the resultant beam diameter Φ at the first plano-convex lens 312 of the optical assemblies 300, 300′, 300″ (FIGS. 3A-3C). Further, the first convex lens 342, the intermediate concave lens 344, and the second convex lens 346 may be translatable using a motorized stage or any other known or yet-to-be developed mechanism for moving optical components. Moreover, it should be understood that, in some embodiments, the beam diameter downstream the afocal beam adjustment assembly 340 (exit beam diameter 362) may be equal to the beam diameter Φ and, in other embodiments, the beam diameter downstream the afocal beam adjustment assembly 340 (exit beam diameter 362) may be altered by one or more additional optical components before reaching the first plano-convex lens 312 such that exit beam diameter 362 is different than the beam diameter Φ. In these other embodiments, the afocal beam adjustment assembly 340 may be configured to compensate for this difference to form an exit beam diameter 362 that results in a desired beam diameter Φ at the first plano-convex lens 312, thereby forming an annular infrared beam spot 210 having a desired annular thickness 211.

Referring now to FIG. 5, an optical assembly 300′″ is depicted comprising an afocal beam adjustment assembly 440 positioned upstream the first plano-convex lens 312 (i.e. between the infrared beam source 330 and the axicon lens 310 as depicted in FIG. 5 or positioned between the axicon lens 310 and the first plano-convex lens 312). The afocal beam adjustment assembly 440 comprises a first end 410, a first aperture 414 positioned at the first end 410, a second end 412, and a second aperture 416 positioned at the second end 412. The second aperture 416 comprises a larger diameter than the first aperture 414. Further, the afocal beam adjustment assembly 440 comprises a first expanding optical element 420 and a second expanding optical element 422 each positioned between the first aperture 414 and the second aperture 416. Further, the first convex lens 342, the intermediate concave lens 344, and the second convex lens 346 of FIGS. 4A-4B may be housed within the afocal beam adjustment assembly 440 between the first end 410 and the second end 412.

The first expanding optical element 420 and the second expanding optical element 422 comprise adjustable rings configured to alter the beam diameter of the infrared laser beam 302 as the infrared laser beam 302 traverses the afocal beam adjustment assembly 440. In particular, actuation (e.g., rotation) of the first expanding optical element 420 alters the relative distance between the first convex lens 342 and the intermediate concave lens 344 and actuation (e.g., rotation) of the second expanding optical element 422 alters the relative distance between the intermediate concave lens 344 and the second convex lens 346. Thus, the first and second expanding optical elements 420, 422 are adjustable to adjust the amount of the beam diameter changes (e.g., increases or decreases) within the afocal beam adjustment assembly 440. In one embodiment, actuation of the first expanding optical element 420 may translate the first convex lens 342, actuation of the second expanding optical element 422 may translate the second convex lens 346, and the intermediate concave lens 344 may be in a fixed location. In another embodiment, actuation of the first expanding optical element 420 and/or actuation of the second expanding optical element 422 may translate the intermediate concave lens 344. In yet another embodiment, the afocal beam adjustment assembly 440 may comprise a single expanding optical element configured to translate the intermediate concave lens 344 between fixed first and second convex lenses 342, 346.

Further, in some embodiments, when the infrared laser beam 302 enters the afocal beam adjustment assembly 440 at the first end 410 and exits the afocal beam adjustment assembly 440 at the second end 412 (as depicted in FIG. 5), the afocal beam adjustment assembly 440 increases the beam diameter of the infrared laser beam 302 and when the infrared laser beam 302 enters the afocal beam adjustment assembly 440 at the second end 412 and exits the afocal beam adjustment assembly 440 at the first end 410 (e.g., when the orientation of the afocal beam adjustment assembly 440 is reversed), the afocal beam adjustment assembly 440 decreases the beam diameter of the infrared laser beam 302. However, it should be understood that embodiments are contemplated in which the relative orientation of the first end 410 and the second end 412 with respect to the infrared laser beam 302 does not affect how the beam diameter of the infrared laser beam 302 changes.

Referring again to FIGS. 3B-5, the afocal beam adjustment assemblies 340, 440 may improve laser processing of the transparent workpiece 130 using the infrared laser beam 302 by removing the need for operational downtime to replace one or both of the first plano-convex lens 312 and the second plano-convex lens 314 with lenses having different focal lengths when an annular infrared beam spot 210 with a different annular thickness 211 is desired. For example, it may be desirable to increase the annular thickness 211 of the infrared laser beam 302 when the laser power of the infrared laser beam 302 is increased. While not intending to be limited by theory, irradiating the transparent workpiece 130 with an infrared laser beam 302 comprising increased laser power may damage the transparent workpiece 130.

However, also increasing the annular thickness 211 of the annular infrared beam spot 210 spreads the increased total laser power applied by the infrared laser beam 302 onto the transparent workpiece 130 over a greater surface area of the transparent workpiece 130, thereby reducing the local laser power applied to each discrete surface portion of the transparent workpiece 130 interacting (i.e. via irradiation) with the annular infrared beam spot 210. As one example, an increase in laser power may be useful when separating transparent workpieces 130 that have a low CTE, such as CORNING LOTUS™ and CORNING SAPPHIRE™, each available from Corning Incorporated of Corning, N.Y. Further, an increase in laser power may be useful when the relative translation speed of the annular infrared beam spot 210 and the transparent workpiece 130 is increased, for example, to decrease the separation time of the contour line 110 formed in the transparent workpiece 130. Decreasing the separation time may shorten the manufacturing time required to produce separated transparent workpieces 130 thereby increasing efficiency and reducing cost. An increase in laser power may also be useful for separating thicker transparent workpieces 130.

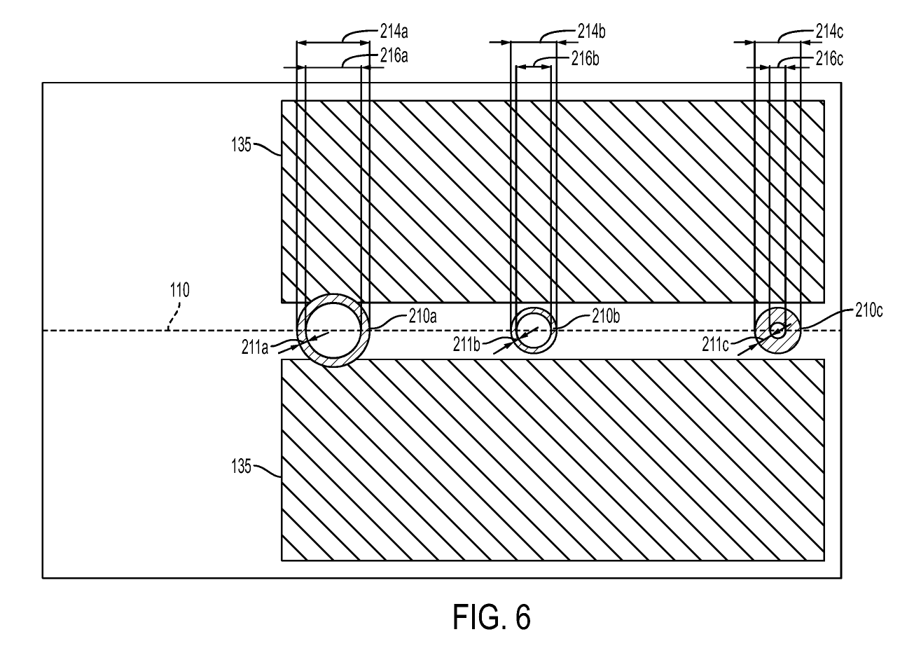

Moreover, referring now to FIG. 6, adjustability of the annular thickness 211 may also be useful to avoid irradiating portions of the transparent workpiece 130 with the infrared laser beam 302. For example, the transparent workpiece 130 may comprise one or more zones of interest 135, which should be avoided during laser processing. As one example, the one or more zones of interest 135 may comprise one or more layers of material disposed on the transparent workpiece 130, such as indium tin oxide coatings, aluminum coatings, zinc coatings, copper coatings, iridescent coatings, antireflective coating, antifrictive coatings, or the like. However, it should be understood the one or more zones of interest 135 may refer to any portion of transparent workpiece 130 on which it is not desirable to irradiate with the laser, regardless of the presence of any additional material layers.

FIG. 6 depicts two zones of interest 135 spaced apart from one another on the transparent workpiece 130 and depicts a contour line 110 extending between the two zones of interest 135. In this example, it may be desirable to separate the contour line 110 by translating the annular infrared beam spot 210 and the transparent workpiece 130 relative to one another along the contour line 110 without the annular infrared beam spot 210 irradiating the zones of interest 135. The use of the afocal beam adjustment assemblies 340, 440 described above may facilitate the alteration of the annular thickness 211 of the annular infrared beam spot 210 to avoid the zones of interest 135. To illustrate, three example annular infrared beam spots 210a-210c are depicted in FIG. 6, for example, a first annular infrared beam spot 210a comprising an inner diameter 216a, an outer diameter 214a, and an annular thickness 211a, a second annular infrared beam spot 210b comprising an inner diameter 216b, an outer diameter 214b, and an annular thickness 211b, and a third annular infrared beam spot 210c comprising an inner diameter 216c, an outer diameter 214c, and an annular thickness 211c.

The first annular infrared beam spot 210a comprises an outer diameter 214b sized such the first annular infrared beam spot 210a irradiates the zones of interest 135. As described above, this is not desirable. Thus, the outer diameter 214a and the inner diameter 216a may be decreased such that the first annular infrared beam spot 210a does not irradiate the zones of interest 135, for example, by altering the relative positioning of the second plano-convex lens 314 and the transparent workpiece 130, such that the first annular infrared beam spot 210a now comprises the second annular infrared beam spot 210b shown in FIG. 6. However, the second annular infrared beam spot 210b comprises a decreased inner diameter 216b and a decreased outer diameter 214b. Thus, if the laser power of the infrared laser beam 302 remains constant, an increased amount laser power will interact with the portions of the transparent workpiece 130 irradiated by the annular infrared beam spot 210 of the infrared laser beam 302, which may damage the transparent workpiece 130. Thus, it may be desirable to increase the annular thickness 211b of the second annular infrared beam spot 210b by increasing the inner diameter 216b using an afocal beam adjustment assembly described above, such that the second annular infrared beam spot 210b now comprises the third annular infrared beam spot 210c shown in FIG. 6. The third annular infrared beam spot 210c retains the decreased outer diameter (now outer diameter 214c) while further decreasing the inner diameter (now inner diameter 216c) and thereby increasing the annular thickness 211c, such that the third annular infrared beam spot 210c avoids irradiating the zones of interest 135 without undesirably increasing the local laser power applied to each discrete portion of the transparent workpiece 130 irradiated by the third annular infrared beam spot 210c.

Referring again to FIGS. 3A-6, the embodiments described herein may enable faster processing speeds when separating the transparent workpiece 130. For example, the infrared laser beam 302 and the transparent workpiece 130 may be translated relative to one another at a speed of at least about 1 mm/s, at least about 5 mm/s, at least about 10 mm/s, at least about 100 mm/s, at least about 1 m/s, at least about 2 mm/s, at least about 5 m/s, at least about 10 m/s, at least about 15 m/s, or even at least about 20 m/s (such as from about 1 mm/s to about 20 m/s, or from about 10 mm/s to about 10 m/s, or from about 100 mm/s to about 2 m/s). In general, faster processing speeds require greater amounts of laser power to achieve the thermal stresses to facilitate spontaneous separation. As noted above, greater laser power can damage the transparent workpiece 130 in conventional separation techniques. However, with the energy concentration distributed away from the contour line in the embodiments described herein, overheating may be avoided which may reduce or eliminate unwanted damage in the transparent workpiece 130. Moreover, increasing the annular thickness 211 of the annular infrared beam spot 210 may also limit overheating, thereby reducing or eliminating unwanted damage in the transparent workpiece 130.

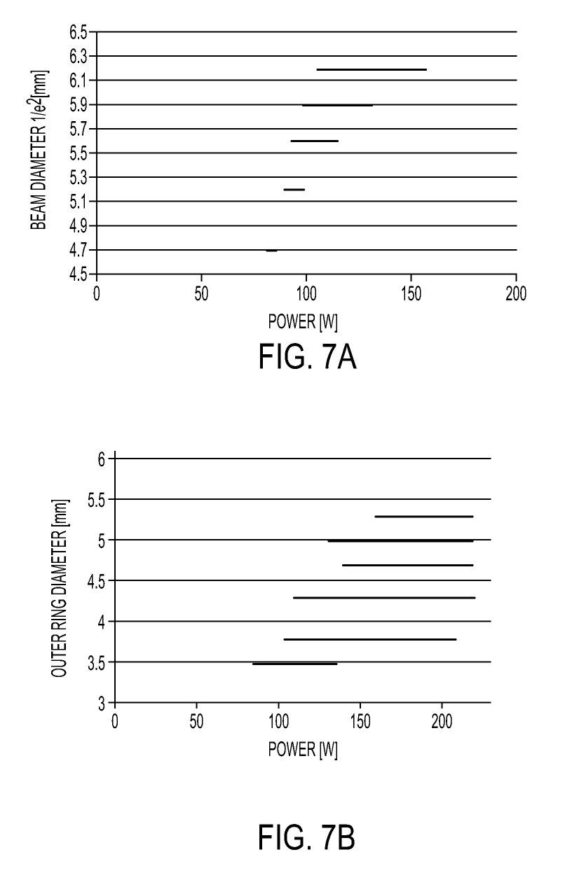

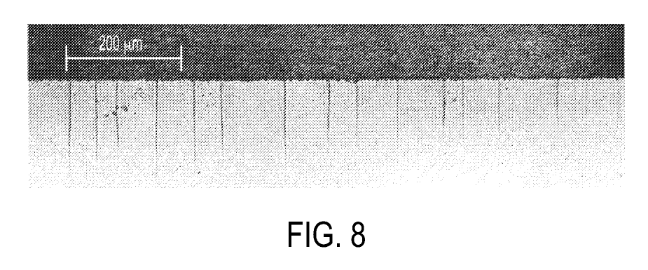

In embodiments, the process of separating the transparent workpiece 130 by infrared laser beam processing as described herein may allow for a greater window of power to be utilized for a given process speed. For example, the data of FIG. 7A represents the conventional separation technique utilizing a Gaussian infrared laser beam projected onto a transparent workpiece at a speed of 200 mm/s, where the beam diameter (i.e., the 1/e² diameter) is graphically depicted as a function of beam power sufficient for separation. FIG. 7B represents an annular infrared beam spot as described herein projected onto a transparent workpiece at a speed of 200 mm/s, where the outer diameter is graphically depicted as a function of suitable beam power. As can be seen in FIGS. 7A and 7B, the infrared beam power range which is suitable for separating the transparent workpiece (i.e., causing spontaneous separation without causing damage to the transparent workpiece such as the laterally cracking depicted in FIG. 8) is broader utilizing the annular beam rather than the Gaussian beam of the conventional process. Thus, for a given processing speed, the power of the infrared laser beam may be more widely varied using the annular beam profile, allowing for more flexibility in processing. According to embodiments, the infrared laser beam may have a power of from about 20 W to about 1000 W, such as from about 50 W to about 300 W, or from about 75 W to about 200 W, and subranges of power and relative to outer diameter as depicted in FIG. 7B.

Referring again to FIGS. 1 and 3A-3C, one embodiment for separating a transparent workpiece 130 includes an initial step of forming a contour line 110 on the surface of the transparent workpiece 130. The contour line 110 defines the intended line of separation and generally includes defects which, when further operated on such as by heating or the like, to cause spontaneous separation of the transparent workpiece 130 along the contour line 110. In a second step following forming of the contour line 110, the infrared laser beam 302 output by the infrared beam source 330 is directed onto the surface of the transparent workpiece 130 along the contour line 110, thereby forming the annular infrared beam spot 210 on the surface of the transparent workpiece 130, as described above. For example, annular infrared beam spot 210 is positioned on the surface of the transparent workpiece 130 such that the contour line 110 generally bisects the annular infrared beam spot 210. That is, the annular infrared beam spot 210 is positioned on the surface of the transparent workpiece 130 such that the contour line 110 lies along a diameter of the annular infrared beam spot 210. The annular infrared beam spot 210 is then traversed over the contour line 110 by moving the annular infrared beam spot 210 relative to the transparent workpiece 130, moving the transparent workpiece 130 relative to the annular infrared beam spot 210, or moving the annular infrared beam spot 210 and the transparent workpiece 130 relative to one another.

As noted hereinabove, the infrared laser beam 302 (via the annular infrared beam spot 210) imparts thermal energy to the transparent workpiece 130 along the contour line 110. In the embodiments described herein, the maximum amount of thermal energy imparted to the transparent workpiece 130 is not directly on the contour line 110, but rather in areas of the transparent workpiece 130 laterally offset and spaced apart from the contour line 110 which mitigates unintended damage to the transparent workpiece 130 such as melting and/or laterally cracking. As the annular infrared beam spot 210 traverses the contour line 110, the infrared laser beam 302 (via the annular infrared beam spot 210) heats up the material of the transparent workpiece 130 causing expansion of the material. This results in the development of compressive stress in the heated areas while tensile stresses develop along the contour line 110 ahead of and behind the annular infrared beam spot 210. These stresses cause the contour line 110 and, more specifically, the defects of the contour line 110 to spontaneously propagate both through the thickness of the transparent workpiece 130 and along the contour line 110 resulting in the spontaneous separation of the transparent workpiece 130 along the contour line 110.

According to one or more embodiments, the present disclosure provides a process for precision cutting and/or separation of transparent workpieces such as, for example, glass workpieces formed from alkaline earth boro-aluminosilicate glass compositions, sapphire, fused silica, or combinations thereof. Such transparent workpieces may be utilized as display and/or TFT (thin film transistor) substrates. Some examples of such glasses or glass compositions suitable for display or TFT use are EAGLE XG®, CONTEGO, and CORNING LOTUS™ available from Corning Incorporated of Corning, N.Y. The alkaline earth boro-aluminosilicate glass compositions may be formulated to be suitable for use as substrates for electronic applications including, without limitation, substrates for TFTs. The glass compositions used in conjunction with TFTs typically have coefficients of thermal expansion (CTE) similar to that of silicon (such as less than 5×10⁻⁶/K, or even less than 4×10⁻⁶/K, for example, approximately 3×10⁻⁶/K, or about 2.5×10⁻⁶/K to about 3.5×10⁻⁶/K), and have low levels of alkali within the glass. Low levels of alkali (e.g., trace amounts of about 0 wt. % to 2 wt. %, such as less than 1 wt. %, for example, less than 0.5 wt. %) may be used in TFT applications because alkali dopants, under some conditions, leach out of glass and contaminate or “poison” the TFTs, possibly rendering the TFTs inoperable. According to embodiments, the laser cutting processes described herein may be used to separate transparent workpieces in a controlled fashion with negligible debris, minimum defects, and low subsurface damage to the edges, preserving workpiece integrity and strength.

As described above, according to some embodiments, the contour line may comprise line defects (sometimes referred to herein as line defects or perforations) produced by interaction of the transparent workpiece with a pulsed laser beam, such as is described in U.S. Publication No. 2015/0360991. This method utilizing a pulsed laser to form defects in the transparent workpiece may be well suited for materials that are transparent to the selected pulsed laser wavelength. This pulsed laser wavelength may be, for example, 1064 nm, 532 nm, 355 nm, or 266 nm. Demonstrations of the method for forming the contour line of defects have been made, for example, by using EAGLE XG® compositions in thicknesses ranging from 0.025 mm to 0.7 mm.

The pulsed laser beam may create multi-photon absorption (MPA) in substantially transparent materials such as glass workpieces. MPA is the simultaneous absorption of two or more photons of identical or different frequencies that excites a molecule from one state (usually the ground state) to a higher energy electronic state (i.e., ionization). The energy difference between the involved lower and upper states of the molecule is equal to the sum of the energies of the involved photons. MPA, also called induced absorption, can be a second-order or third-order process (or higher order), for example, that is several orders of magnitude weaker than linear absorption. It differs from linear absorption in that the strength of second-order induced absorption may be proportional to the square of the light intensity, for example, and thus it is a nonlinear optical process.

The perforation step that creates the contour line 110 may utilize an ultra-short pulse laser in combination with optics that generate a focal line to fully perforate a transparent workpiece formed from, for example, various glass compositions. In some embodiments, the pulse duration of the individual pulses is in a range of from about 1 picosecond to about 100 picoseconds, such as from about 5 picoseconds to about 20 picoseconds, and the repetition rate of the individual pulses may be in a range from about 1 kHz to 4 MHz, such as in a range from about 10 kHz to about 3 MHz, or from about 10 kHz to about 650 kHz.

In addition to a single pulse operation at the aforementioned individual pulse repetition rates, the pulses may be produced in bursts of two pulses or more (such as, for example, 3 pulses, 4 pulses, 5 pulses, 10 pulses, 15 pulses, 20 pulses, or more per pulse burst, such as from 1 to 30 pulses per pulse burst, or from 5 to 20 pulses per pulse burst). The pulses within the burst may be separated by a duration that is in a range from about 1 nsec to about 50 nsec, for example, from about 10 nsec to about 30 nsec, such as about 20 nsec. The burst repetition frequency may be in a range of from about 1 kHz to about 2 MHz, such as from about 1 kHz to about 200 kHz. Bursting or producing pulse bursts is a type of laser operation where the emission of pulses is not in a uniform and steady stream but rather in tight clusters of pulses. The pulse burst laser beam may have a wavelength selected based on the material of the transparent workpiece being operated on such that the material of the transparent workpiece is substantially transparent at the wavelength. The average laser power per burst measured at the material may be at least about 40 μJ per mm of thickness of material. For example, in embodiments, the average laser power per burst may be from about 40 μJ/mm to about 2500 μJ/mm, or from about 500 μJ/mm to about 2250 μJ/mm. In a specific example, for 0.5 mm to 0.7 mm thick Corning EAGLE XG® transparent workpiece, pulse bursts of from about 300 μJ to about 600 μJ may cut and/or separate the workpiece, which corresponds to an exemplary range of about 428 μJ/mm to about 1200 μJ/mm (i.e., 300 μJ/0.7mm for 0.7 mm EAGLE XG® glass and 600 μJ/0.5 mm for a 0.5 mm EAGLE XG® glass).

The transparent workpiece may be translated relative to the pulsed laser beam (or the pulsed laser beam may be translated relative to the glass) to create contour lines that trace out the shape of a desired part with defects. The pulsed laser may create hole-like defect zones, referred to herein as line defects, which may penetrate the full depth of the glass. It should be understood that while sometimes described as “holes” or “hole-like,” the defects disclosed herein may generally not be void spaces, but are rather portions of the workpiece which has been modified by laser processing as described herein. In display or TFT type glasses these line defects may generally be spaced apart from one another by a distance of from about 5 microns to about 20 microns. For example, suitable spacing between the line defects may be from about 1 microns to about 30 microns, such as from about 5 microns to about 15 microns, from about 5 microns to about 12 microns, from about 7 microns to about 15 microns, or from about 7 microns to about 12 microns for the TFT/display glass compositions).

As defined herein, the internal diameter of a line defect is the internal diameter of the modified area defining the line defect in the transparent workpiece. For example, in some embodiments described herein, the internal diameter of the line defect may be less than or equal to about 1 micron, for example, less than or equal to about 500 nm, less than or equal to about 400 nm, or even less than or equal to about 300 nm. In embodiments, the internal diameter of a line defects may be as large as the spot diameter of the laser beam focal line. In embodiments, the pulsed laser beam focal line may have an average spot diameter in a range of from about 0.1 micron to about 30 microns, such as from about 0.1 microns to about 10 microns, from about 0.1 microns to about 5 microns, for example, from about 1.5 microns to about 3.5 microns. Once a workpiece is separated along the contour line, the line defects may potentially still be observable at the separated surface and may have a width comparable to the internal diameters of the line defects. Thus, widths of line defects on a cut surface of a workpiece prepared by embodiments of methods described herein may have widths of from about 0.1 micron to about 5 microns.

Beyond the perforation of a single transparent workpiece, the process may also be used to perforate stacks of transparent workpieces, such as stacks of sheets of glass, and may fully perforate glass stacks of up to a few mm total height with a single laser pass. The glass stacks additionally may have air gaps in various locations. According to another embodiment, ductile layers such as adhesives may be disposed between the glass stacks. However, the pulsed laser process will still, in a single pass, fully perforate both the upper and lower glass layers of such a stack.

Without being bound by theory, it is believed that one of the enablers of the described perforation process is the high aspect ratio of the line defects created by the ultra-short pulsed laser. This high aspect ratio allows creation of a contour line that extends, in some embodiments, from the top to the bottom surfaces of the workpiece to be cut. In principle, this line defect may be created by a single pulse and if necessary, additional pulses may be used to increase the extension of the affected area (depth and width).

In embodiments, the pulsed laser beam focal line may have a length in a range of from about 0.1 mm to about 10 mm, or from about 0.5 mm to about 5 mm, for example, about 1 mm, about 2 mm, about 3 mm, about 4 mm, about 5 mm, about 6 mm, about 7 mm, about 8 mm, or about 9 mm, or a length in a range of from about 0.1 mm to about 2 mm, or from 0.1 mm to about 1 mm. In embodiments, the pulsed laser beam focal line may have an average spot diameter in a range of from about 0.1 micron to about 5 microns. The line defects each may have a diameter of from about 0.1 microns to 30 microns, for example, from about 0.25 microns to about 5 microns (e.g., from about 0.25 microns to about 0.75 microns).

The generation of a focal line may be performed by sending a Gaussian laser beam into an axicon lens, in which case a beam profile known as a Gauss-Bessel beam is created. Such a beam diffracts much more slowly (e.g., the beam may maintain single micron diameter spot sizes for ranges of hundreds of microns or millimeters as opposed to a few tens of microns or less) than a Gaussian beam. Hence the depth of focus or length of intense interaction with the material may be much larger than when using a Gaussian beam only. Other forms of slowly diffracting or non-diffracting beams may also be used, such as Airy beams.

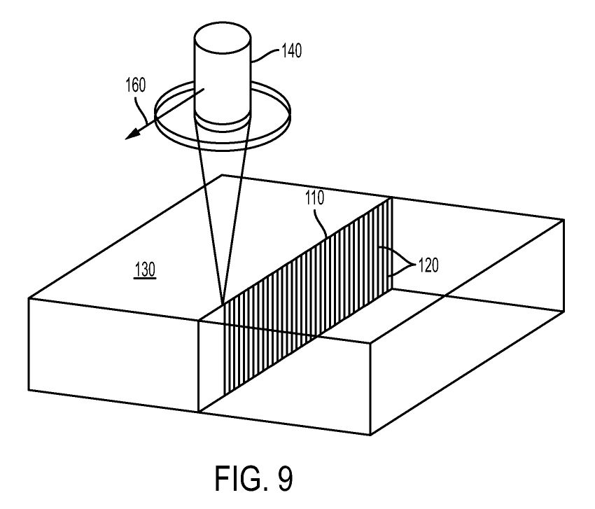

As illustrated in FIG. 9, a contour line 110 comprising a plurality of line defects 120 may be formed by processing the transparent workpiece 130 with an ultra-short pulsed laser beam 140 moving in processing direction 160. The line defects 120 may extend, for example, through the thickness of the transparent workpiece 130, and may be orthogonal to the major (flat) surfaces of the transparent workpiece 130. While contour lines may be linear, like the contour line 110 illustrated in FIG. 9, the contours lines may also be nonlinear (i.e., having a curvature). Curved contour lines may be produced, for example, by translating either the transparent workpiece 130 or pulsed laser beam 140 with respect to the other in two dimensions instead of one dimension. While in some transparent workpieces the material properties (e.g., absorption, CTE, stress, composition, etc.) and pulsed laser parameters chosen for processing the transparent workpiece may alone induce self-separation, in the embodiments described herein, a heat treatment (e.g., with an infrared laser) is utilized to separate the transparent workpiece 130 at the contour line 110 following formation of the contour line 110. As illustrated in FIG. 9, a plurality of line defects 120 may define the contour line 110.

For some transparent workpieces, the distance, or periodicity, between adjacent line defects 120 along the direction of the contour lines 110 may be at least about 0.1 micron or 1 micron and less than or equal to about 20 microns or even 30 microns. For example, in some transparent workpieces, the periodicity between adjacent line defects 120 may be from about 0.5 to about 15 microns, or from about 3 microns to about 10 microns, or from about 0.5 microns to about 3.0 microns. For example, in some transparent workpieces the periodicity between adjacent line defects 120 may be from about 0.5 micron to about 1.0 micron. However for alkaline earth boro-aluminosilicate glass compositions, especially those 0.5 mm thick or of greater thickness, the periodicity between adjacent line defects 120 may be at least about 1 microns, such as at least about 5 microns, or from about 1 microns to about 15 microns.

According to various embodiments, there are several methods to create a perforated contour line by processing with a pulsed laser beam. The optical method of forming the focal line may take multiple forms, using donut shaped laser beams and spherical lenses, axicon lenses, diffractive elements, or other methods to form the linear region of high intensity. The type of laser (picosecond, femtosecond, etc.) and wavelength (infrared, green, UV, etc.) may also be varied, as long as sufficient optical intensities are reached to create breakdown of the workpiece material in the region of focus on the transparent workpiece through nonlinear optical effects. According to one or more embodiments, the laser may be a pulse burst laser which allows for control of the energy deposition with time by adjusting the number of pulses within a given burst.

In the present embodiments, an ultra-short pulsed laser may be used to create a high aspect ratio vertical line defect in a consistent, controllable, and repeatable manner. According to one embodiment, optical techniques are used to create a line focus of a high intensity laser beam within a transparent workpiece. In one embodiment, an axicon lens element is used in an optical lens assembly to create a region of high aspect ratio, taper-free line defects using ultra-short (picoseconds or femtosecond duration) Bessel beams. In other words, the axicon condenses the laser beam into a high intensity region of cylindrical shape and high aspect ratio (long length and small diameter). Due to the high intensity created with the condensed laser beam, nonlinear interaction of the electromagnetic field of the laser and the workpiece material may occur and the laser energy may be transferred to the workpiece to effect formation of defects that become constituents of the contour line. However, it is important to realize that in the areas of the material where the laser energy intensity is not high (e.g., the glass volume of workpiece surrounding the central convergence line), the material of the transparent workpiece is largely unaffected by the laser and there is no mechanism for transferring energy from the laser to the material. As a result, nothing happens to the workpiece directly at the focal zone when the laser intensity is below the nonlinear threshold.

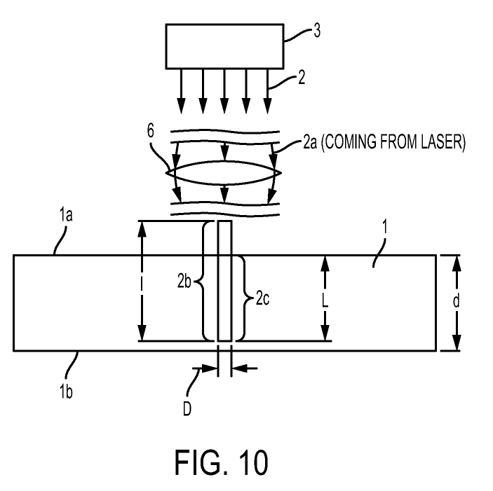

Now referring to FIG. 10, a method for forming a perforated contour line (e.g., the contour line 110) may include focusing a pulsed laser beam 2 from a laser apparatus 3 into a pulsed laser beam focal line 2b oriented along the beam propagation direction. As shown in FIG. 10, a laser (not shown) emits the pulsed laser beam 2, which has a beam portion 2a incident to the optical assembly 6. The optical assembly 6 turns the incident laser beam into a pulsed laser beam focal line 2b on the output side over a defined expansion range along the beam direction (length 1 of the focal line). A transparent workpiece 1 is positioned in the beam path to at least partially overlap the pulsed laser beam focal line 2b of pulsed laser beam 2. The laser beam focal line is thus directed into the transparent workpiece 1. Reference 1 a designates the surface of the transparent workpiece 1 facing the optical assembly 6 or the laser, respectively, and reference 1b designates the reverse surface of transparent workpiece 1. The transparent workpiece 1 has a depth d measured perpendicularly to the top surface 1a and the bottom surface 1b of the transparent workpiece 1 (i.e., to the workpiece plane), where the top surface 1a and the bottom surface 1b are planar.

As depicted in FIG. 10, the transparent workpiece 1 is aligned perpendicular to the longitudinal beam axis and thus behind the pulsed laser beam focal line 2b produced by the optical assembly 6 (the transparent workpiece 1 is perpendicular to the plane of the drawing). The pulsed laser beam focal line 2b being oriented or aligned along the beam direction, the transparent workpiece 1 is positioned relative to the pulsed laser beam focal line 2b such that the pulsed laser beam focal line 2b starts before the top surface 1a of the transparent workpiece 1 and stops before the bottom surface 1b of the transparent workpiece 1 (i.e., the pulsed laser beam focal line 2b terminates within the transparent workpiece 1 and does not extend beyond the bottom surface 1b). In the overlapping area of the pulsed laser beam focal line 2b with the transparent workpiece 1 (i.e., in the workpiece material covered by the pulsed laser beam focal line 2b), the pulsed laser beam focal line 2b generates (assuming suitable laser intensity along the pulsed laser beam focal line 2b, which intensity is ensured by the focusing of pulsed laser beam 2 on a section of length 1, i.e. a line focus of length 1) an extensive section 2c (aligned along the longitudinal beam direction) along which an induced absorption is generated in the workpiece material. The induced absorption produces a line defect formation in the workpiece material along the extensive section 2c. The line defect is a microscopic (e.g., having an internal diameter of from about 100 nm to about 0.5 microns) elongated defect in the transparent workpiece 1 which may be generated by using a single high energy burst of multiple laser pulses. A series of these line defects creates a perforation pattern in the transparent workpiece along the contour line. For example, individual line defects may be created at rates of several hundred kilohertz (i.e., several hundred thousand line defects per second). With relative motion between the pulsed laser beam focal line 2b and the transparent workpiece 1, these line defects may be placed adjacent to one another (spatial separation varying from sub-micron to many microns as desired). This spatial separation (pitch) may be selected to facilitate separation of the workpiece with a heat source, such as the infrared laser. In some embodiments, the line defect is a “through defect”, which is a defect that extends from top surface 1a of the transparent workpiece 1 to bottom surface 1b of the transparent workpiece 1. The line defect formation is not only local, but over the entire length of the extensive section 2c of the induced absorption. The length of the extensive section 2c of induced absorption (which corresponds to the length of the overlapping of the pulsed laser beam focal line 2b with the transparent workpiece 1) is labeled with reference L. The internal diameter of the defect area (i.e., the defect) at the extensive section 2c of the induced absorption is labeled with reference D. This internal diameter D basically corresponds to the average diameter δ of the pulsed laser beam focal line 2b, that is, an average spot diameter in a range of between about 0.1 micron and about 5 microns.

Representative optical assemblies 6, which may be applied to generate the pulsed laser beam focal line 2b, as well as a representative optical setup, in which these optical assemblies may be applied, are described below. All assemblies or setups are based on the description above so that identical references are used for identical components or features or those which are equal in their function. Therefore only the differences are described below.

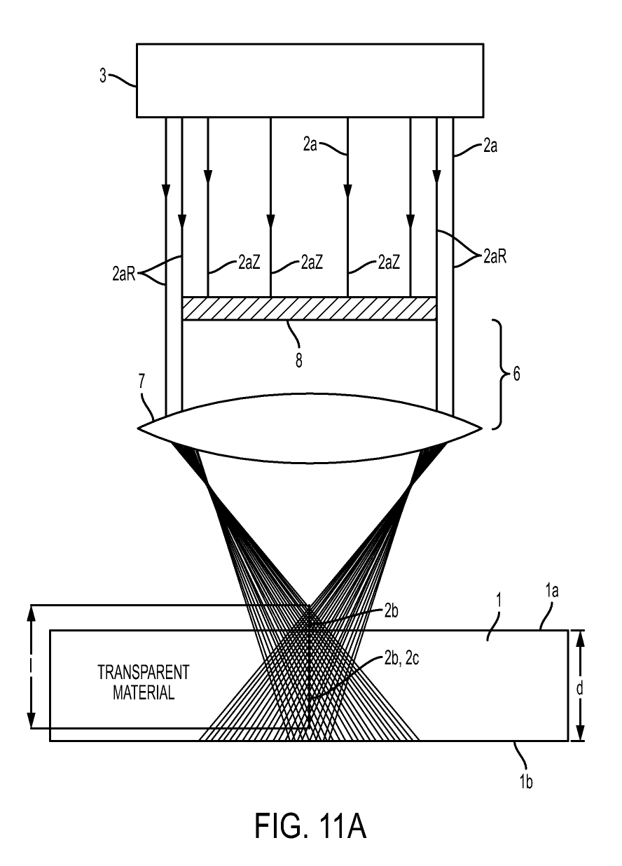

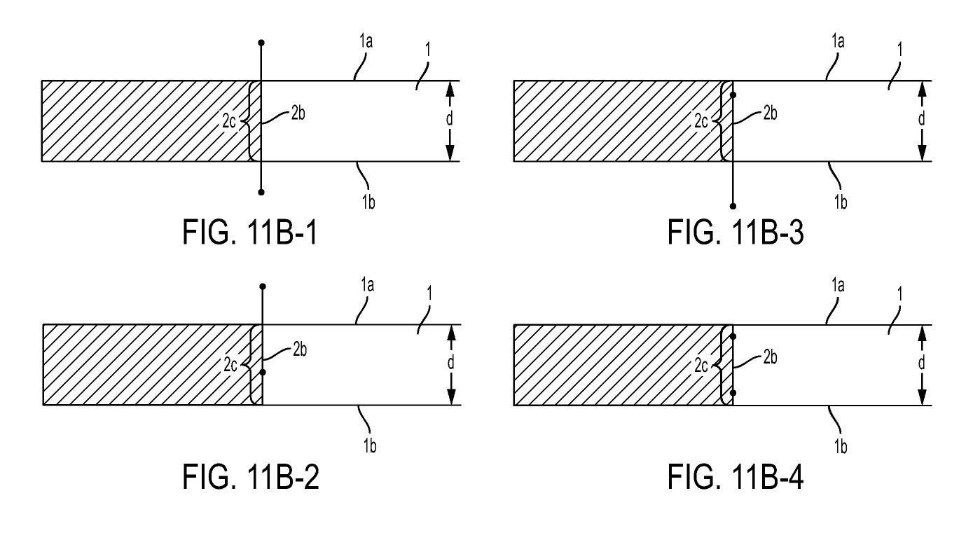

According to FIG. 11A, the beam portion 2a of the laser beam emitted by laser apparatus 3 incident to the optical assembly 6 is first directed onto an aperture 8 (e.g., a circular aperture) which is opaque to the wavelength of laser radiation used. Aperture 8 is oriented perpendicular to the longitudinal beam axis and is centered on the central portion of the beam portion 2a. The diameter of aperture 8 is selected in such a way that the laser radiation near the center of beam portion 2a (i.e., the central beam portion, here labeled with 2aZ) hit the aperture and is completely absorbed by it. Only the beams in the outer perimeter range of beam portion 2a (i.e., marginal rays, here labeled with 2aR) are not absorbed by the aperture 8 due to the reduced aperture size compared to the beam diameter, and pass aperture 8 laterally and hit the marginal areas of the focusing lens 7 of the optical assembly 6, which, in this embodiment, is designed as a spherically cut, bi-convex lens.

As illustrated in FIG. 11A, the pulsed laser beam focal line 2b may not only be a single focal point for the laser beam, but rather a series of focal points for different rays in the laser beam. The series of focal points form an elongated focal line of a defined length, shown in FIG. 11A as the length 1 of the pulsed laser beam focal line 2b. Focusing lens 7 may be centered on the central beam and may be designed as a non-corrected, bi-convex focusing lens in the form of a common, spherically cut lens. As an alternative, aspheres or multi-lens systems deviating from ideally corrected systems, which do not form an ideal focal point but a distinct, elongated focal line of a defined length, may also be used (i.e., lenses or systems which do not have a single focal point). The zones of the lens thus focus along the pulsed laser beam focal line 2b, subject to the distance from the lens center. The diameter of aperture 8 across the beam direction may be approximately 90% of the diameter of the beam portion 2a (defined by the distance required for the intensity of the beam to decrease to 1/e² of the peak intensity) and approximately 75% of the diameter of the focusing lens 7 of the optical assembly 6. The pulsed laser beam focal line 2b of a focusing lens 7 (e.g., a non aberration-corrected spherical lens) generated by blocking out the beam bundles in the center is thus used. FIG. 11A shows a section in one plane through the central beam, and the complete three-dimensional bundle may be seen when the depicted beams are rotated around the pulsed laser beam focal line 2b.

FIG. 11B-1 through FIG. 11B-4 show (not only for the optical assembly in FIG. 11A, but also for any other applicable optical assembly 6) that the position of the pulsed laser beam focal line 2b may be controlled by suitably positioning and/or aligning the optical assembly 6 relative to the transparent workpiece 1 as well as by suitably selecting the parameters of the optical assembly 6. As FIG. 11B-1 illustrates, the length 1 of the pulsed laser beam focal line 2b may be adjusted in such a way that it exceeds the workpiece depth d (here by factor 2). If the transparent workpiece 1 is placed (viewed in longitudinal beam direction) centrally to the pulsed laser beam focal line 2b, an extensive section 2c of induced absorption may be generated over the entire workpiece thickness. The pulsed laser beam focal line 2b may have a length 1 in a range of from about 0.01 mm to about 100 mm or in a range of from about 0.1 mm to about 10 mm. Various embodiments may be configured to have a pulsed laser beam focal line 2b with a length 1 of about 0.1 mm, about 0.2 mm, about 0.3 mm, about 0.4 mm, about 0.5 mm, about 0.7 mm, about 1 mm, about 2 mm, about 3 mm, about 4 mm, or about 5 mm e.g., from about 0.5 mm to about 5 mm.

In the case shown in FIG. 11B-2, a pulsed laser beam focal line 2b of length 1 is generated which generally corresponds to the workpiece depth d. Since the transparent workpiece 1 is positioned relative to the pulsed laser beam focal line 2b in such a way that the pulsed laser beam focal line 2b starts at a point outside the transparent workpiece 1, the length 1 of the extensive section 2c of induced absorption (which extends from the workpiece surface to a defined workpiece depth, but not to the bottom surface 1b) is smaller than the length 1 of the pulsed laser beam focal line 2b. FIG. 11B-3 shows the case in which the transparent workpiece 1 (viewed along a direction perpendicular to the beam direction) is positioned above the starting point of the pulsed laser beam focal line 2b so that, as in FIG. 11B-2, the length 1 of the pulsed laser beam focal line 2b is greater than the length 1 of the extensive section 2c of induced absorption in the transparent workpiece 1. The pulsed laser beam focal line 2b thus starts within the transparent workpiece 1 and extends beyond the bottom surface 1b of the transparent workpiece 1. FIG. 11B-4 shows the case in which the focal line length 1 is smaller than the workpiece depth d so that, in the case of a central positioning of the transparent workpiece 1 relative to the pulsed laser beam focal line 2b viewed in the direction of incidence, the pulsed laser beam focal line 2b starts near the top surface 1a within the transparent workpiece 1 and ends near the bottom surface 1b within the transparent workpiece 1 (e.g., 1=0.75 d).

It may be particularly advantageous to position the pulsed laser beam focal line 2b in such a way that at least one of top surface 1a or the bottom surface 1b is covered by the focal line (e.g. the setup of FIG. 11B-2 or FIG. 11B-3), so that the extensive section 2c of induced absorption starts at least on one surface of the workpiece. In this way it is possible to achieve virtually ideal cuts while avoiding ablation, feathering, and particulation at the surface.

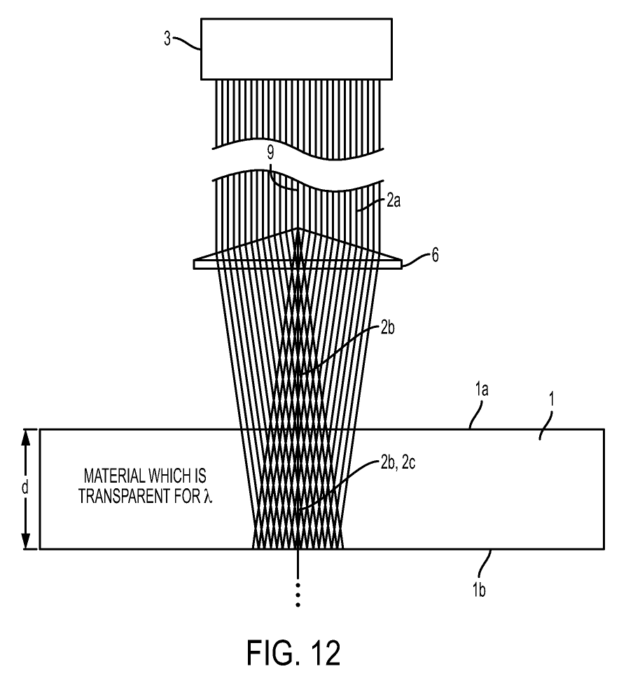

FIG. 12 depicts another embodiment of an optical assembly 6. The basic construction follows the one described in FIG. 11A so that only the differences are described below. The depicted optical assembly in FIG. 12 utilizes optics with a non-spherical free surface in order to generate the pulsed laser beam focal line 2b, which is shaped in such a way that a focal line of defined length 1 is formed. For this purpose, aspheres may be used as optic elements of the optical assembly 6. In FIG. 12, for example, a so-called conical prism, also referred to as axicon, is used. An axicon is a conically cut lens which forms a spot source on a line along the optical axis (or transforms a laser beam into a ring). The cone angle of the axicon in the example is approximately 10°. However, it should be understood that other ranges of the axicon cone angle may also be utilized. The apex of the axicon 9 is directed towards the incidence direction and centered on the beam center. Since the pulsed laser beam focal line 2b produced by the axicon 9 starts within the interior of the axicon, the transparent workpiece 1 (here aligned perpendicularly to the main beam axis) may be positioned in the beam path directly behind axicon 9.

As FIG. 12 shows, it is also possible to shift the transparent workpiece 1 along the beam direction due to the optical characteristics of the axicon while remaining within the range of the pulsed laser beam focal line 2b. The extensive section 2c of the induced absorption in the material of the transparent workpiece 1 therefore extends over the entire workpiece depth d. However, the depicted layout may be subject to the following restrictions: since the region of the pulsed laser beam focal line 2b formed by axicon 9 begins within axicon 9, a significant part of the laser energy is not focused into the extensive section 2c of induced absorption of the pulsed laser beam focal line 2b, which is located within the material, in the situation where there is a separation between axicon 9 and the workpiece. Furthermore, length 1 of the pulsed laser beam focal line 2b is related to the beam diameter through the refractive indices and cone angles of axicon 9. This is why, in the case of relatively thin materials (e.g., several millimeters), the total focal line is much longer than the thickness of the workpiece, having the effect that much of the laser energy is not focused in the thickness of the material.

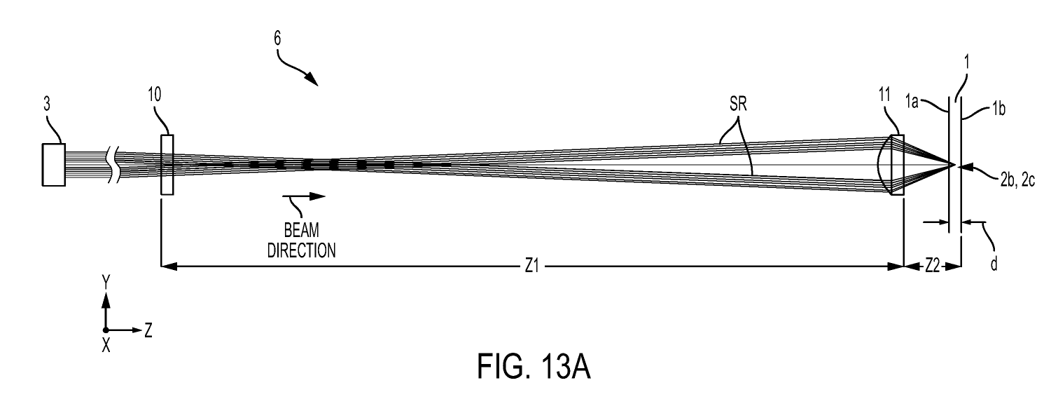

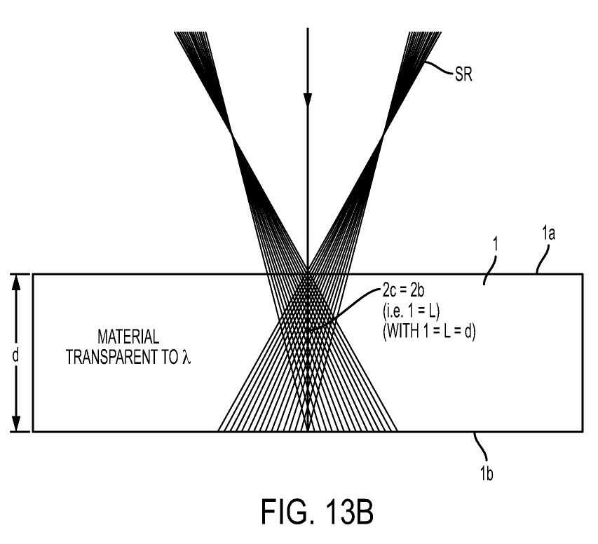

For this reason, it may be desirable to use an optical assembly 6 that includes both an axicon and a focusing lens. FIG. 13A depicts such an optical assembly 6 in which a first optical element with a non-spherical free surface designed to form a pulsed laser beam focal line 2b is positioned in the beam path from laser apparatus 3. In the case shown in FIG. 13A, this first optical element is an axicon 10 with a cone angle of 5° positioned perpendicularly to the beam direction and centered on beam from laser apparatus 3. The apex of the axicon 10 is oriented towards the beam direction. A second, focusing optical element, here the plano-convex lens 11 (the curvature of which is oriented towards the axicon), is positioned in the beam direction at a distance z1 from the axicon 10. The distance z1 may be approximately 300 mm and is selected such that the laser radiation formed by axicon 10 is circularly incident on the outer radial portion of lens 11. Lens 11 focuses the circular radiation on the output side at a distance Z2, in this case approximately 20 mm from lens 11, on a pulsed laser beam focal line 2b of a defined length, in this case 1.5 mm. The effective focal length of lens 11 is 25 mm in this embodiment. The circular transformation of the laser beam by axicon 10 is labeled with the reference SR.

FIG. 13B depicts the formation of the pulsed laser beam focal line 2b or the extensive section 2c of induced absorption in the material of the transparent workpiece 1 according to the optical assembly 6 of FIG. 13A. The optical characteristics of both elements 10, 11 as well as their positioning is selected such that the length 1 of the pulsed laser beam focal line 2b in the beam direction is the same as the depth d of the transparent workpiece 1. In some embodiments, an exact positioning of the transparent workpiece 1 along the beam direction may be necessary in order to position the pulsed laser beam focal line 2b exactly between the top surface 1a and the bottom surface 1b of the transparent workpiece 1, as shown in FIG. 13B.

In another embodiment, instead of the plano-convex lens depicted in FIG. 13A, it is also possible to use a focusing meniscus lens or another higher-order corrected focusing lens (e.g., an asphere, multi-lens system).

In order to generate relatively short pulsed laser beam focal lines 2b using the combination of an axicon and a lens depicted in FIG. 13A, it may be necessary to select a very small beam diameter of the laser beam incident on the axicon. This has the practical disadvantage that the centering of the beam onto the apex of the axicon must be very precise and that the result is very sensitive to directional variations of the laser such as beam drift stability. Furthermore, a tightly collimated laser beam may be highly divergent, that is the beam bundle may become blurred over short distances due to light deflection.

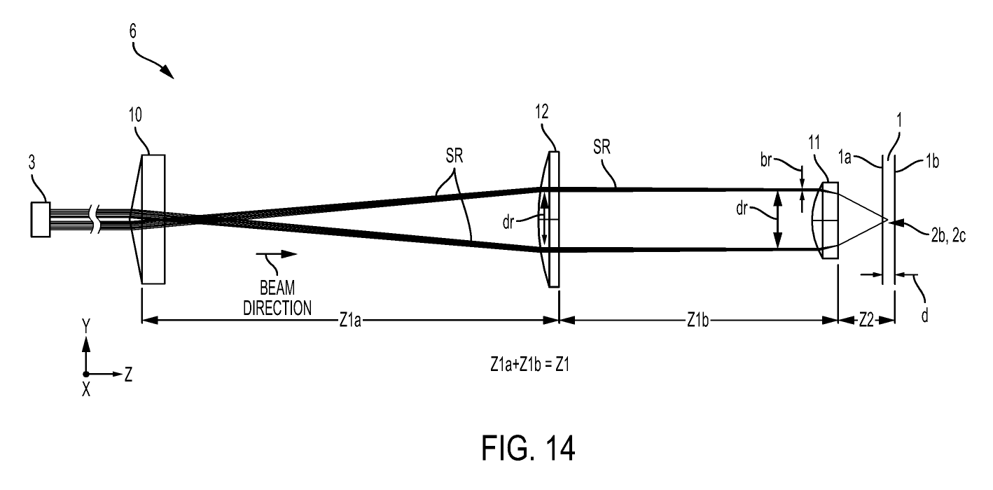

As shown in FIG. 14, both effects may be avoided by including another lens, a collimating lens 12, in the optical assembly 6. The additional collimating lens 12 serves to tightly adjust the circular illumination of focusing lens 11. The focal length f′ of collimating lens 12 is selected such that the desired circle diameter dr results from the distance z1a from the axicon to the collimating lens 12, which is equal to f. The desired width br of the ring may be adjusted via the distance z1b between the collimating lens 12 and the focusing lens 11. As a matter of pure geometry, the small width of the circular illumination leads to a short focal line. A minimum may be achieved at distance P.

The optical assembly 6 depicted in FIG. 14 is thus based on the one depicted in FIG. 13A so that only the differences are described below. The collimating lens 12, here also designed as a plano-convex lens with its curvature towards the beam direction is placed centrally in the beam path between axicon 10 (with its apex towards the beam direction) on one side and the plano-convex lens 11 on the other side. The distance between the collimating lens 12 from axicon 10 is referred to as z1a, the distance between the focusing lens 11 from collimating lens 12 is z1b, and the distance of the pulsed laser beam focal line 2b from the focusing lens 11 is z2. As shown in FIG. 14, the circular radiation SR formed by axicon 10, which is incident divergently and under the circle diameter dr on the collimating lens 12, is adjusted to the required circle width br along the distance z1b for an approximately constant circle diameter dr at the focusing lens 11. In the case shown, a very short pulsed laser beam focal line 2b is intended to be generated so that the circle width br of approximately 4 mm at the collimating lens 12 is reduced to approximately 0.5 mm at lens 11 due to the focusing properties of the collimating lens 12 (circle diameter dr is 22 mm in the example). In the depicted example, it is possible to achieve a length of the focal line 1 of less than 0.5 mm using a typical laser beam diameter of 2 mm, a focusing lens 11 with a focal length f=25 mm, a collimating lens with a focal length f=150 mm, and choosing distances Z1a=Z1b=140 mm and Z2=15 mm.

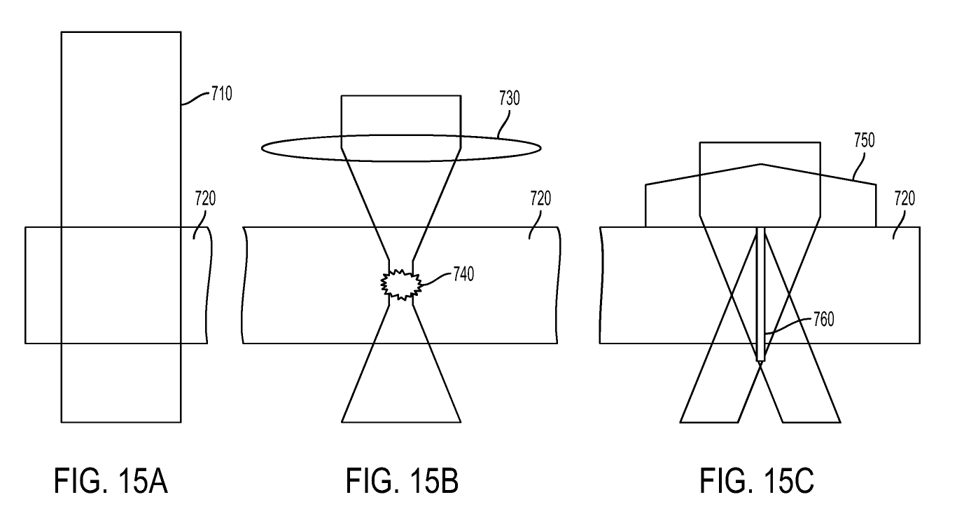

FIGS. 15A-15C illustrate the laser-matter interaction at different laser intensity regimes. In the first case, shown in FIG. 15A, the unfocused pulsed laser beam 710 goes through a transparent workpiece 720 without introducing any modification to the transparent workpiece 720. In this particular case, the nonlinear effect is not present because the laser energy density (or laser energy per unit area illuminated by the beam) is below the threshold necessary to induce nonlinear effects. The higher the energy density, the higher the intensity of the electromagnetic field. Therefore, as shown in FIG. 15B, when the laser beam is focused by spherical lens 730 to a smaller spot size, the illuminated area is reduced and the energy density increases, triggering the nonlinear effect that modifies the transparent material to permit formation of a fault line only in the volume where that condition is satisfied. In this way, if the beam waist of the focused laser is positioned at the surface of the workpiece, modification of the surface will occur. In contrast, if the beam waist of the focused laser is positioned below the surface of the workpiece, nothing happens at the surface when the energy density is below the threshold of the nonlinear optical effect. However, when the focal point 740 is positioned in the bulk of the transparent workpiece 720, the laser intensity is high enough to trigger multi-photon non-linear effects, thus inducing damage to the material. In another embodiment, as shown in FIG. 15C in the case of an axicon, the diffraction pattern of an axicon lens 750, or alternatively a Fresnel axicon, creates interference that generates a Bessel-shaped intensity distribution (i.e., the high intensity cylinder 760) and only in that volume is the intensity sufficient to create nonlinear absorption and modification of the material of the transparent workpiece 720. The diameter of the high intensity cylinder 760 in which the Bessel-shaped intensity distribution is sufficient to create nonlinear absorption and modification to the material is also the spot diameter of the laser beam focal line. Spot diameter D of a Bessel beam may be expressed as D=(2.4048λ)/(2πB), where λ is the laser beam wavelength and B is a function of the axicon angle.

For the purpose of cutting alkaline earth boro-aluminosilicate glass compositions, according to some exemplary embodiments, a picosecond pulsed laser (e.g., a 1064 nm, or 532 nm picosecond pulsed laser) which produces bursts of multiple pulses in combination with line-focus beam forming optics may be used to line defects in the glass composition. However, it is noted that other pulsed lasers may also be utilized in the perforation processes described herein.

For example, a display/TFT glass composition with a thickness of up to 0.7 mm may be positioned so that it is within the region of the focal line produced by the optics. With a focal line of about 1 mm in length, a 1064 nm picosecond laser that produces output power of about 24 W or more at a burst repetition rate of 200 kHz (about 120 μJ/burst or more) measured at the transparent workpiece, the optical intensities in the focal line region may be sufficient to create non-linear absorption in the glass composition. The pulsed laser beam may have an average laser burst energy measured, at the material, greater than 40 μJ per mm of thickness of the workpiece. For some glasses, the average laser burst energy utilized may be as great as 2500 μJ per mm of thickness of the material, for example from about 40 μJ/mm to about 2500 μJ/mm, from about 400 μJ/mm to about 1300 μJ/mm, or from about 550 μJ/mm to about 1000 μJ/mm, because the energy density is sufficient to make a thorough damage track of line defects in the workpiece while minimizing the extent of micro cracking orthogonal to the perforated line or cut edge. This “average pulse burst laser energy” per mm may also be referred to as an average per-burst linear energy density, or an average energy per laser pulse burst per mm of thickness of the material. A region of damaged, ablated, vaporized, or otherwise modified material within the glass composition may be created that approximately follows the linear region of high optical intensity created by the laser beam focal line.

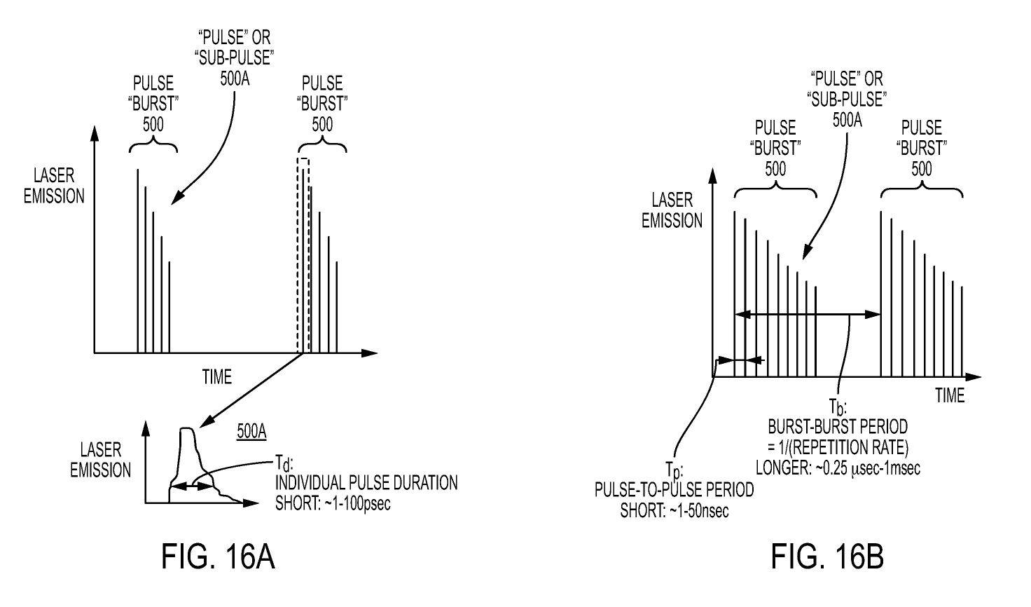

Now referring to FIGS. 16A and 16B, it should be understood that the typical operation of such a picosecond laser described herein creates a burst 500 of pulses 500A. Each burst 500 contains multiple individual pulses 500A (such as at least two pulses, at least 5 pulses, at least 7 pulses, at least 8 pulses, at least 9 pulses, at least 10 pulses, at least 15 pulses, at least 20 pulses, or even more pulses) of very short duration. That is, a burst is a group of pulses, and the bursts are separated from one another by a longer duration than the separation of individual adjacent pulses within each burst. According to one or more embodiments, for cutting or perforating display glass/TFT glass compositions, the number of pulses per burst may be from about 1 to 30 (such as from 5 to 20). Pulses 500A have pulse duration T_{d} of up to 100 psec (for example, 0.1 psec, 5 psec, 10 psec, 15 psec, 18 psec, 20 psec, 22 psec, 25 psec, 30 psec, 50 psec, 75 psec, or any range therebetween). The energy or intensity of each individual pulse 500A within the burst may not be equal to that of other pulses within the burst, and the intensity distribution of the multiple pulses within a burst 500 often follows an exponential decay in time governed by the laser design.

In some embodiments, each pulse 500A within the burst 500 of the exemplary embodiments described herein is separated in time from the subsequent pulse in the burst by a duration Tₚ of from about 1 nsec to about 50 nsec (e.g., from about 10 nsec to about 50 nsec, or from about 10 nsec to about 30 nsec, with the time often governed by the laser cavity design). For a given laser, the time separation Tₚ between adjacent pulses within a burst 500 may be relatively uniform (e.g., within about 10% of one another). For example, in some embodiments, each pulse within a burst is separated in time from the subsequent pulse by approximately 20 nsec (50 MHz). For example, for a laser that produces pulse separation Tₚ of about 20 nsec, the pulse to pulse separation Tₚ within a burst is maintained within about ±10%, or about ±2 nsec. The time between each burst of pulses (i.e., the time separation T_{b} between bursts) will be much longer. For example, the time between each burst of pulses may be from about 0.25 microseconds to about 1000 microseconds, e.g., from about 1 microsecond to about 10 microseconds, or from about 3 microseconds to about 8 microseconds. In some of the exemplary embodiments of the laser described herein, the time separation T_{b} is about 5 microseconds for a laser with a burst repetition rate of about 200 kHz. The laser burst repetition rate is related to the time Tb between the first pulse in a burst to the first pulse in the subsequent burst (laser burst repetition rate=1/Tb). In some embodiments, the laser burst repetition rate may be in a range of from about 1 kHz to about 4 MHz. In embodiments, the laser burst repetition rates may be, for example, in a range of from about 10 kHz to 650 kHz. The time T_{b} between the first pulse in each burst to the first pulse in the subsequent burst may be from about 0.25 microsecond (4 MHz burst repetition rate) to about 1000 microseconds (1 kHz burst repetition rate), for example from about 0.5 microseconds (2 MHz burst repetition rate) to about 40 microseconds (25 kHz burst repetition rate), or from about 2 microseconds (500 kHz burst repetition rate) to about 20 microseconds (50 k Hz burst repetition rate). The exact timing, pulse duration, and burst repetition rate may vary depending on the laser design, but short pulses (T_{d}<20 psec and preferably T_{d}≤15 psec) of high intensity have been shown to work particularly well.

The energy required to modify the material may be described in terms of the burst energy (i.e., the energy contained within a burst where each burst 500 contains a series of pulses 500A), or in terms of the energy contained within a single laser pulse (many of which may comprise a burst). The energy per burst may be from about 25 μJ to about 750 μJ, e.g., from about 50 μJ to about 500 μJ, or from about 50 μJ to about 250 μJ. For some glass compositions, the energy per burst may be from about 100 μJ to about 250 μT. However, for display or TFT glass compositions, the energy per burst may be higher (e.g., from about 300 μJ to about 500 μJ, or from about 400 μJ to about 600 μJ, depending on the specific display/TFT glass composition of the workpiece). The energy of an individual pulse within the burst will be less, and the exact individual laser pulse energy will depend on the number of pulses 500A within the burst 500 and the rate of decay (e.g., exponential decay rate) of the laser pulses with time as shown in FIGS. 16A and 16B. For example, for a constant energy/burst, if a pulse burst contains 10 individual laser pulses 500A, then each individual laser pulse 500A will contain less energy than if the same burst 500 had only 2 individual laser pulses.

The use of a pulsed laser beam capable of generating such bursts is advantageous for cutting or modifying transparent materials, for example glass. In contrast with the use of single pulses spaced apart in time by the repetition rate of the single-pulsed laser, the use of a burst sequence that spreads the laser energy over a rapid sequence of pulses within the burst 500 allows access to larger timescales of high intensity interaction with the material than is possible with single-pulse lasers. While a single-pulse may be expanded in time, the intensity within the pulse is reduced as roughly one over the pulse width. Therefore, if a 10 psec single pulse is expanded to a 10 nsec pulse, the intensity is reduced by roughly three orders of magnitude. Such a reduction may reduce the optical intensity to the point where non-linear absorption is no longer significant, and light-material interaction is no longer sufficient for cutting.

In contrast, with a pulse burst laser, the intensity during each pulse 500A within the burst 500 may remain relevantly high (for example, three 10 psec pulses 500A spaced apart in time by approximately 10 nsec still allows the energy within each pulse burst to be approximately three times higher than that of a single 10 psec pulse) and the laser interacts with the material over a timescale that is three orders of magnitude larger. For example, often 10 psec pulses 500A spaced apart in time by approximately 10 nsec results in the energy within each pulse burst to be approximately ten times higher than that of a single 10 psec pulse and the laser interacts with the material over a timescale that is now orders of magnitude larger. In one embodiment, the required amount of burst energy to modify the material will depend on the workpiece material composition and the length of the line focus used to interact with the workpiece. The longer the interaction region, the more the energy is spread out, and higher burst energy will be required. The exact timing, pulse duration, and burst repetition rates may vary depending on the laser design, but short pulses times (e.g., less than about 15 psec, or even less than or equal to about 10 psec) of high intensity pulses may be exemplary in some embodiments.

Without intending to be limited by theory, a defect is formed in the material when a single burst of pulses strikes essentially the same location on the transparent workpiece. That is, multiple laser pulses within a single burst correspond to a single line defect in the transparent workpiece. Since the workpiece is translated (e.g., by a constantly moving stage or the beam moved relative to the workpiece), the individual pulses within the burst cannot be at exactly the same spatial location on the glass. However, the individual pulses may be within 1 μm of one another (i.e., they effectively strike the glass at essentially the same location). For example, the pulses may strike the glass at a spacing, sp, from one another where 0<sp≤500 nm. When, for example, a glass location is hit with a burst of 20 pulses the individual pulses within the burst strike the glass within 250 nm of each other. Thus, in some embodiments 1 nm<sp<250 nm. In some embodiments 1 nm<sp<100 nm.

In one or more embodiments, for the purposes of cutting or separating the workpiece, pulse burst energy may be from about 100 μJ to about 600 μJ per burst, such as from about 300 μJ to about 600 μJ per burst. Working outside this range may result in successful separation of other glasses, but not display (or TFT) glass compositions. For some display glass types the pulse burst energy may be from about 300 μJ to about 500 μJ, or for other display type glass from about 400 μJ to about 600 μJ. A pulse burst energy of 400 μJ to 500 μJ may work well for many display type glass compositions. Energy density within the line focus may be optimized for specific display or TFT glasses. For example, for both EAGLE XG and CONTEGO glasses, a suitable range for the pulse burst energy may be from about 300 to about 500 μJ and the line focus may be from about 1.0 mm to about 1.4 mm (where the line focus length is determined by the optical configuration).

In one or more embodiments, relatively low pulsed laser energy densities (e.g., below 300 μJ) may form perforations which do not form as desired, causing the fracture between defects to not readily materialize during infrared laser processing, leading to increased break resistance (also referred to herein as a break strength) in display glass. If the energy density of the pulsed laser beam is too high (e.g., greater than or equal to 600 μJ, or even greater than 500 μJ the heat damage may be greater, causing the crack connecting the perforation to stray and not form along the desired path and the break resistance (break strength) of the display (or TFT) glass to dramatically increase.

In view of the foregoing description, it should be understood that laser separation by infrared laser beam may be enhanced by utilizing an infrared laser beam which forms an annular infrared beam spot on the transparent workpiece that projects maximum intensity over the areas adjacent a contour line containing defects rather than directly onto the contour line. Further, it should be understood that it may be desirable to alter an annular thickness of the annular infrared beam spot, for example, increase the annular thickness of the annular infrared beam spot when the laser power of the infrared laser beam is increased and/or when an outer diameter of the annular infrared beam spot is decreased. In view of the foregoing description, this adjustable annular thickness may be achieved using optical assemblies that include an afocal beam adjustment assembly having one or more adjustable optical elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for laser processing a transparent workpiece, the method comprising:
forming a contour line in the transparent workpiece, the contour line comprising defects in the transparent workpiece; and
directing an infrared laser beam output by an infrared beam source through an afocal beam adjustment assembly and onto the transparent workpiece along or near the contour line to separate the transparent workpiece along the contour line, wherein:
the infrared laser beam forms an annular infrared beam spot on a surface of the transparent workpiece;
the infrared laser beam comprises an entrance beam diameter upstream the afocal beam adjustment assembly and an exit beam diameter downstream the afocal beam adjustment assembly;
the annular infrared beam spot comprises an inner diameter, an outer diameter, and an annular thickness;
the afocal beam adjustment assembly comprises one or more adjustable optical elements; and
adjusting at least one of the one or more adjustable optical elements alters the exit beam diameter of the infrared laser beam, thereby altering the annular thickness of the annular infrared beam spot formed on the surface of the transparent workpiece.

2. The method of claim 1, wherein:
the afocal beam adjustment assembly comprises a first convex lens, a second convex lens, and an intermediate concave lens positioned between and optically coupled to the first convex lens and the second convex lens;
the intermediate concave lens is one of the one or more adjustable optical elements; and is translatable between the first convex lens and the second convex lens; and
the afocal beam adjustment assembly is positioned relative to the infrared beam source such that the first convex lens is positioned upstream the second convex lens.

3. The method of claim 2, wherein:
the first convex lens and the second convex lens each comprise focal lengths that are equal; and
the focal length of the first convex lens and the focal length of the second convex lens are each twice a focal length of the intermediate concave lens.

4. The method of claim 2, wherein when the intermediate concave lens is positioned closer to the first convex lens than the second convex lens, the afocal beam adjustment assembly is in a beam expanding mode such that the exit beam diameter is greater than the entrance beam diameter.

5. The method of claim 2, wherein when the intermediate concave lens is positioned closer to the second convex lens than the first convex lens, the afocal beam adjustment assembly is in a beam narrowing mode such that the exit beam diameter is less than the entrance beam diameter.

6. The method of claim 1, wherein increasing the exit beam diameter increases the annular thickness of the annular infrared beam spot formed on the surface of the transparent workpiece and decreasing the exit beam diameter increases the annular thickness of the annular infrared beam spot formed on the surface of the transparent workpiece.

7. The method of claim 1, wherein the outer diameter of the annular infrared beam spot is from about 0.5 mm to about 20 mm.

8. The method of claim 1, wherein the inner diameter of the annular infrared beam spot is from about 5% to about 95% of the outer diameter of the annular infrared beam spot.

9. The method of claim 1, wherein a greater distribution of cumulated energy from the infrared laser beam is located in areas adjacent to the contour line than directly on the contour line.

10. The method of claim 9, wherein a greater distribution of cumulated energy from the infrared laser beam is located in areas adjacent to the contour line on both sides of the contour line than directly on the contour line.

11. The method of claim 1, wherein the annular infrared beam spot is centered on the contour line.

12. The method of claim 1, wherein the infrared beam source is a CO₂ laser, a CO laser, a solid state laser, a laser diode, or combinations thereof.

13. The method of claim 1, wherein the transparent workpiece comprises an alkaline earth boro-aluminosilicate glass, sapphire, fused silica, or combinations thereof.

14. The method of claim 1, further comprising translating the annular infrared beam spot and the transparent workpiece relative to one another along the contour line, thereby separating the transparent workpiece along the contour line.

15. The method of claim 14, wherein the annular infrared beam spot and the transparent workpiece are translated relative to one another at a speed from about 1 mm/s to about 10 m/s.

16. The method of claim 1, wherein the infrared laser beam has a power of from about 20 W to about 1000 W.

17. The method of claim 1, wherein the transparent workpiece has a CTE of less than or equal to about 5×10⁻⁶/K.

18. The method of claim 1, wherein the transparent workpiece has a thickness of from about 50 microns to about 10 mm.

19. The method of claim 1, wherein forming the contour line comprises:
focusing a pulsed laser beam into a pulsed laser beam focal line oriented along a beam propagation direction and directed into the transparent workpiece, the pulsed laser beam focal line generating an induced absorption within the transparent workpiece, and the induced absorption producing a defect along the pulsed laser beam focal line within the transparent workpiece;
translating the transparent workpiece and the pulsed laser beam focal line relative to each other along the contour line, thereby laser forming a plurality of defects along the contour line within the transparent workpiece, wherein a spacing between adjacent defects is from 1 microns to 30 microns; and
wherein the pulsed laser beam produces pulse bursts with from about 1 pulses per pulse burst to about 30 pulses per pulse burst and the pulse burst energy is from about 100 μJ to about 600 μJ per pulse burst.

20. A method for laser processing a transparent workpiece, the method comprising:
focusing a pulsed laser beam into a pulsed laser beam focal line directed into the transparent workpiece, the pulsed laser beam focal line producing a defect within the transparent workpiece;
translating the transparent workpiece and the pulsed laser beam focal line relative to each other thereby laser forming a plurality of defects along a contour line within the transparent workpiece; and
directing an infrared laser beam through an afocal beam adjustment assembly and onto the transparent workpiece along or near the contour line to separate the transparent workpiece along the contour line, wherein:
the infrared laser beam forms an annular infrared beam spot on a surface of the transparent workpiece;
the annular infrared beam spot comprises an inner diameter, an outer diameter, and an annular thickness; and
the afocal beam adjustment assembly comprises one or more adjustable optical elements configured to adjust a beam diameter of the infrared laser beam and thereby alter the annular thickness of the annular infrared beam spot formed on the surface of the transparent workpiece.

21. The method of claim 20, further comprising translating the annular infrared beam spot and the transparent workpiece relative to one another along the contour line, thereby separating the transparent workpiece along the contour line.

22. The method of claim 20, wherein a spacing between adjacent defects is from 5 microns to 15 microns.

23. The method of claim 20, wherein the pulsed laser beam produces pulse bursts with from about 1 pulses per pulse burst to about 30 pulses per pulse burst and the pulse burst energy is from about 100 μJ to about 600 μJ per pulse burst.

24. The method of claim 20, wherein the pulsed laser beam produces pulse bursts with from about 9 pulses per pulse burst to about 20 pulses per pulse burst, and the pulse burst energy is from about 300 μJ per pulse burst to about 500 μJ per pulse burst.

25. The method of claim 20, wherein:
a spacing between adjacent defects is from about 7 microns to about 12 microns; and
the pulsed laser beam produces pulse bursts with from about 5 pulses per pulse burst to about 15 pulses per pulse burst, and the pulse burst energy is from about 400 μJ per pulse burst to about 600 μJ per pulse burst.

26. The method of claim 20, wherein the pulses of the pulse bursts have a duration of from about 1 picosecond to about 100 picoseconds.

27. The method of claim 20, wherein the pulse bursts have a repetition rate in a range of from about 10 kHz and about 3 MHz.

28. The method of claim 20, wherein the pulsed laser beam focal line has an average spot diameter in a range of from about 0.1 micron to about 10 microns.

29. An optical assembly comprising:
an infrared beam source configured to output an infrared laser beam;
an axicon lens positioned downstream the infrared beam source,
a first plano-convex lens positioned downstream the axicon lens;
a second plano-convex lens positioned downstream the first plano-convex lens, wherein when the infrared laser beam traverses each of the axicon lens, the first plano-convex lens, and the second plano-convex lens and thereafter irradiates a transparent workpiece positioned downstream the second plano-convex lens, the infrared laser beam forms an annular infrared beam spot comprising an inner diameter, an outer diameter, and an annular thickness on a surface of the transparent workpiece; and
an afocal beam adjustment assembly positioned between the infrared beam source and the first plano-convex lens, wherein:
the afocal beam adjustment assembly comprises one or more adjustable optical elements; and
adjusting at least one of the one or more adjustable optical elements alters the annular thickness of the annular infrared beam spot formed on the surface of the transparent workpiece.

30. The optical assembly of claim 29, wherein:
the afocal beam adjustment assembly comprises a first convex lens, a second convex lens, and an intermediate concave lens positioned between and optically coupled to the first convex lens and the second convex lens;
the intermediate concave lens is one of the one or more adjustable optical elements; and is translatable between the first convex lens and the second convex lens; and
the afocal beam adjustment assembly is positioned relative to the infrared beam source such that the first convex lens is positioned upstream the second convex lens.

31. The optical assembly of claim 30, wherein:
the first convex lens and the second convex lens each comprise focal lengths that are equal; and
the focal length of the first convex lens and the focal length of the second convex lens are each twice a focal length of the intermediate concave lens.

32. The optical assembly of claim 30, wherein:
when the intermediate concave lens is positioned closer to the first convex lens than the second convex lens, the afocal beam adjustment assembly is in a beam expanding mode such that the infrared laser beam comprises an exit beam diameter upstream the afocal beam adjustment assembly that is greater than an entrance beam diameter of the infrared laser beam downstream the afocal beam adjustment assembly;
when the intermediate concave lens is positioned closer to the second convex lens than the first convex lens, the afocal beam adjustment assembly is in a beam narrowing mode such that the exit beam diameter is less than the entrance beam diameter;
increasing the exit beam diameter increases the annular thickness of the annular infrared beam spot formed on the surface of the transparent workpiece; and
decreasing the exit beam diameter increases the annular thickness of the annular infrared beam spot formed on the surface of the transparent workpiece.

33. The optical assembly of claim 29, wherein the afocal beam adjustment assembly is positioned between the infrared beam source and the axicon lens.

34. The optical assembly of claim 29, wherein the afocal beam adjustment assembly is positioned between the axicon lens and the first plano-convex lens.
